(19) United States
(12) Patent Application Publication
(10) Pub. No.: US 2024/0308799 A1
(43) Pub. Date: Sep. 19, 2024

(54) UNEVEN ROLLER, MEDIUM TRANSPORTATION DEVICE, RECORDING APPARATUS, POST-PROCESSING APPARATUS, RELAY APPARATUS, UNEVEN RING, AND MANUFACTURING METHOD OF UNEVEN ROLLER

(71) Applicant: SEIKO EPSON CORPORATION, Tokyo (JP)

(72) Inventors: Kohei UENO, MATSUMOTO-SHI (JP); Hirohisa KODAIRA, MATSUMOTO-SHI (JP)

(21) Appl. No.: 18/605,579

(22) Filed: Mar. 14, 2024

(30) Foreign Application Priority Data
Mar. 17, 2023 (JP) 2023-042800

(51) Int. Cl. B65H 5/06; B41J 3/44; B41J 11/00; B41J 13/03; B41J 13/076

(52) U.S. Cl. CPC B65H 5/062; B41J 3/44; B41J 11/0005; B41J 11/0024; B41J 13/03; B41J 13/076; B65H 2404/113; B65H 2404/1311; B65H 2404/1361; B65H 2404/14

(57) ABSTRACT

Provided is an uneven roller of which a surface coming into contact with a medium is provided with a plurality of protrusions and recesses, the uneven roller including a shaft portion, a reference portion mounted on the shaft portion, a ring portion that is positioned closer to a side, to which a first direction along an axial direction of the shaft portion extends, than the reference portion is and that is mounted on the shaft portion, and a restriction portion that is positioned closer to the side, to which the first direction extends, than the ring portion is and that is mounted on the shaft portion to restrict movement of the ring portion in the first direction. The ring portion is composed of a plurality of uneven rings disposed along the axial direction, the uneven ring including a plurality of protrusion portions disposed along a circumferential direction.

The present application is based on, and claims priority from JP Application Serial Number 2023-042800, filed Mar. 17, 2023, the disclosure of which is hereby incorporated by reference herein in its entirety.

### BACKGROUND

### 1. Technical Field

The present disclosure relates to an uneven roller of which a surface coming into contact with a medium, onto which liquid is discharged, is provided with protrusions and recesses. The present disclosure also relates to a medium transportation device including the uneven roller. The present disclosure also relates to a recording apparatus, a post-processing apparatus, and a relay apparatus each of which includes the medium transportation device. The present disclosure also relates to an uneven ring that constitutes an uneven roller of which a surface coming into contact with a medium, onto which liquid is discharged, is provided with a plurality of protrusions and recesses. The present disclosure also relates to a manufacturing method of an uneven roller.

### 2. Related Art

Disclosed in JP-A-2007-168992 is a configuration in which the entire surface of a paper sheet is embossed by using a male roller and a female roller as units that correct a curl formed at the paper sheet.

Although a configuration in which the entire surface of a paper sheet is embossed by using a male roller and a female roller is disclosed in JP-A-2007-168992, a detailed configuration of the male roller or the female roller (particularly, the way in which an embossing portion is provided) is not described therein.

The shape of a roller used to emboss a paper sheet is complicated in comparison with a normal roller, which is to be considered at the time of manufacture.

### SUMMARY

According to an aspect of the present disclosure, there is provided an uneven roller of which a surface coming into contact with a medium, onto which liquid is discharged, is provided with a plurality of protrusions and recesses, the uneven roller including a shaft portion, a reference portion mounted on the shaft portion, a ring portion that is positioned closer to a side, to which a first direction along an axial direction of the shaft portion extends, than the reference portion is and that is mounted on the shaft portion, and a restriction portion that is positioned closer to the side, to which the first direction extends, than the ring portion is and that is mounted on the shaft portion to restrict movement of the ring portion in the first direction. The ring portion is composed of a plurality of uneven rings disposed along the axial direction, the uneven ring including a plurality of protrusion portions disposed along a circumferential direction.

According to another aspect of the present disclosure, there is provided a medium transportation device including the above-described uneven roller that is rotationally driven and a facing roller nipping, together with the uneven roller, a medium onto which liquid is discharged.

According to still another aspect of the present disclosure, there is provided a recording apparatus including a recording unit performing recording by discharging liquid onto a medium and the above-described medium transportation device that transports the medium on which the recording is performed by the recording unit.

According to still another aspect of the present disclosure, there is provided a post-processing apparatus directly or indirectly coupled to a recording apparatus performing recording by discharging liquid onto a medium, the post-processing apparatus including a post-processing unit performing post-processing on the medium on which the recording is performed by the recording apparatus and the above-described medium transportation device that transports, toward the post-processing unit, the medium on which the recording is performed by the recording apparatus.

According to still another aspect of the present disclosure, there is provided a relay apparatus that is disposed between a recording apparatus performing recording by discharging liquid onto a medium and a post-processing apparatus performing post-processing on the medium on which the recording is performed by the recording apparatus and that passes the medium from the recording apparatus to the post-processing apparatus, the relay apparatus including the above-described medium transportation device.

According to still another aspect of the present disclosure, there is provided an uneven ring constituting an uneven roller of which a surface coming into contact with a medium, onto which liquid is discharged, is provided with a plurality of protrusions and recesses. The uneven ring is configured to be mounted on a shaft portion constituting the uneven roller and includes a plurality of protrusion portions disposed along a circumferential direction.

According to still another aspect of the present disclosure, there is provided a manufacturing method of an uneven roller of which a surface coming into contact with a medium, onto which liquid is discharged, is provided with a plurality of protrusions and recesses, the manufacturing method including mounting a reference portion on a shaft portion, forming a ring portion by repeatedly sliding an uneven ring, which includes a plurality of protrusion portions disposed along a circumferential direction, onto the shaft portion toward the reference portion a plurality of times, and mounting, onto the shaft portion, a restriction portion restricting movement of the ring portion in a direction away from the reference portion.

### BRIEF DESCRIPTION OF THE DRAWINGS

FIG. 1 is a view showing an overall configuration of a recording system.

FIG. 2 is a view showing a first basic configuration for curl correction.

FIG. 3 is a view showing a second basic configuration for curl correction.

FIG. 4 is a perspective view of an uneven roller.

FIG. 5 is a partially enlarged perspective view of the uneven roller.

FIG. 6 is a perspective view of an uneven ring.

FIG. 7 is a perspective view showing a method of assembling the uneven roller.

FIG. 8 is a cross-sectional perspective view of a portion of the uneven roller.

FIG. 9 is a perspective view showing the method of assembling the uneven roller.

FIG. 10 is a perspective view showing the method of assembling the uneven roller.

FIG. 11 is a partially enlarged perspective view of an uneven roller.

FIG. 12 is a perspective view of an uneven ring.

FIG. 13 is a flowchart showing the flow of a method of manufacturing the uneven roller.

FIG. 14 is an external perspective view of a medium transportation device.

FIG. 15 is a front view of the inside of the medium transportation device.

FIG. 16 is a partially enlarged perspective view of the inside of the medium transportation device.

FIG. 17 is a cross-sectional view of the medium transportation device.

FIG. 18 is a sectional view of an uneven roller.

FIG. 19 is a plan view of the uneven roller.

FIG. 20 is a perspective view showing a method of assembling the uneven roller.

FIG. 21 is a partially enlarged view of the uneven roller.

FIG. 22 is a view showing an embodiment in which outer diameters of an uneven roller are made different from each other.

FIG. 23 is a perspective view showing a method of assembling an uneven roller.

FIG. 24 is a view illustrating the disposition and the angle of contact of a claw portion with respect to a facing ring.

FIG. 25 is a cross-sectional view of a transportation roller pair of which both of rollers facing each other are uneven rollers.

FIG. 26 is a cross-sectional view of a medium transportation device including a plurality of transportation roller pairs.

FIG. 27 is a view schematically showing protrusions and recesses formed at a medium.

FIG. 28 is a perspective view of the medium transportation device including the plurality of transportation roller pairs.

FIG. 29 is a side view of the medium transportation device including the plurality of transportation roller pairs.

FIG. 30 is a cross-sectional view of a medium transportation device including a plurality of transportation roller pairs.

FIG. 31 is a front view of an encoder provided at a motor.

FIG. 32 is a perspective view of a transportation roller pair of which both of rollers facing each other are uneven rollers.

FIG. 33 is a perspective view of a restriction portion.

FIG. 34 is a view showing a first gear and a second gear meshing with each other.

FIG. 35 is an enlarged view of part XXXV of FIG. 34.

FIG. 36 is a view showing only an uneven roller in which gears in FIG. 35 are omitted.

FIG. 37 is a sectional view of a shaft portion provided with a heater.

### DESCRIPTION OF EMBODIMENTS

Hereinafter, the present disclosure will be schematically described.

According to a first aspect of the present disclosure, there is provided an uneven roller of which a surface coming into contact with a medium, onto which liquid is discharged, is provided with a plurality of protrusions and recesses, the uneven roller including a shaft portion, a reference portion mounted on the shaft portion, a ring portion that is positioned closer to a side, to which a first direction along an axial direction of the shaft portion extends, than the reference portion is and that is mounted on the shaft portion, and a restriction portion that is positioned closer to the side, to which the first direction extends, than the ring portion is and that is mounted on the shaft portion to restrict movement of the ring portion in the first direction. The ring portion is composed of a plurality of uneven rings disposed along the axial direction, the uneven ring including a plurality of protrusion portions disposed along a circumferential direction.

According to the present aspect, a plurality of protrusions are formed at the medium by the uneven roller, so that curl of the medium can be corrected. Here, since the ring portion of the uneven roller can be configured by mounting the plurality of uneven rings between the reference portion and the restriction portion, it is possible to easily configure the uneven rollers having different specifications by changing the shape of the uneven ring with the shaft portion used as a common component and thus the cost of members can be reduced.

In addition, by changing the number of the uneven rings, it is possible to easily change the length of the ring portion in the axial direction and to easily manufacture the uneven rollers having different dimensions.

In addition, a job to be performed when wear or the like of a portion of the ring portion occurs is simply replacing the uneven ring of a corresponding portion. Therefore, it is possible to suppress the required cost in comparison with the case of replacement of the entire uneven roller and to cope with requests for reuse and waste minimisation.

A second aspect of the present disclosure is an aspect that is subordinate to the first aspect and in which the plurality of uneven rings constituting the ring portion have the same shape as each other.

According to the present aspect, since the plurality of uneven rings constituting the ring portion have the same shape as each other, the cost of the uneven rings can be suppressed.

A third aspect of the present disclosure is an aspect that is subordinate to the first aspect and in which the plurality of protrusion portions of the uneven ring are arranged in a row in the circumferential direction.

According to the present aspect, since the plurality of protrusion portions of the uneven ring are arranged in a row in the circumferential direction, the width of the uneven rings can be made reduced. Accordingly, the length of the ring portion in the axial direction can be adjusted more easily.

Note that the present aspect may be an aspect that is subordinate to the second aspect instead of being subordinate to the first aspect.

A fourth aspect of the present disclosure is an aspect that is subordinate to the first aspect and in which two of the uneven rings that are adjacent to each other are configured to engage with each other.

According to the present aspect, since the two of the uneven rings that are adjacent to each other are configured to engage with each other, the two adjacent uneven rings can be restrained from rotating relative to each other such that the phases thereof are made offset from each other.

Note that the present aspect may be an aspect that is subordinate to the second aspect or the third aspect instead of being subordinate to the first aspect.

A fifth aspect of the present disclosure is an aspect that is subordinate to the fourth aspect and in which the uneven ring includes a reference portion side engaging portion configured to engage with the reference portion.

According to the present aspect, since the uneven ring includes the reference portion side engaging portion configured to engage with the reference portion, the uneven ring that is adjacent to the reference portion and the reference portion can be restrained from rotating relative to each other such that the phases thereof are made offset from each other.

Note that the present aspect may be an aspect that is subordinate to any one of the first to third aspects instead of the fourth aspect.

A sixth aspect of the present disclosure is an aspect that is subordinate to the fifth aspect and in which the uneven ring includes a restriction portion side engaging portion configured to engage with the restriction portion.

According to the present aspect, since the uneven ring includes the restriction portion side engaging portion configured to engage with the restriction portion, the uneven ring that is adjacent to the restriction portion and the restriction portion can be restrained from rotating relative to each other such that the phases thereof are made offset from each other.

Note that the present aspect may be an aspect that is subordinate to any one of the first to fourth aspects instead of the fifth aspect.

A seventh aspect of the present disclosure is an aspect that is subordinate to the fourth aspect and in which the uneven ring includes a reference portion side engaging portion configured to engage with the reference portion and a restriction portion side engaging portion configured to engage with the restriction portion and the reference portion side engaging portion and the restriction portion side engaging portion are configured to engage with each other.

According to the present aspect, since the uneven ring includes a reference portion side engaging portion configured to engage with the reference portion and a restriction portion side engaging portion configured to engage with the restriction portion and the reference portion side engaging portion and the restriction portion side engaging portion are configured to engage with each other, it is not necessary to separately provide a configuration for the positioning of the uneven rings and thus the configuration can be simplified.

Note that the present aspect may be an aspect that is subordinate to any one of the first to third aspects instead of the fourth aspect.

An eighth aspect of the present disclosure is an aspect that is subordinate to the seventh aspect and in which the plurality of uneven rings include a first uneven ring and a second uneven ring positioned closer to the side, to which the first direction extends, than the first uneven ring is and a plurality of protrusion portions of the first uneven ring and a plurality of protrusion portions of the second uneven ring are disposed at different positions in the circumferential direction in a state where the restriction portion side engaging portion of the first uneven ring and the reference portion side engaging portion of the second uneven ring engage with each other.

According to the present aspect, since the plurality of protrusion portions of the first uneven ring and the plurality of protrusion portions of the second uneven ring are disposed at different positions in the circumferential direction, it is possible to suppress formation of a noticeable line at the medium along the axial direction, that is, a medium width direction.

A ninth aspect of the present disclosure is an aspect that is subordinate to the seventh aspect and in which the uneven ring includes a base portion into which the shaft portion is inserted and the protrusion portions protruding in a radial direction of the shaft portion from the base portion and the reference portion side engaging portion is provided at the base portion.

According to the present aspect, since the uneven ring includes the base portion into which the shaft portion is inserted and the protrusion portions protruding in the radial direction of the shaft portion from the base portion and the reference portion side engaging portion is provided at the base portion, it is possible to provide the reference portion side engaging portion without influence on disposition of the protrusion portions.

Note that the present aspect may be an aspect that is subordinate to the fifth aspect or the eighth aspect instead of being subordinate to the seventh aspect.

A tenth aspect of the present disclosure is an aspect that is subordinate to the seventh aspect and in which the uneven ring includes a base portion into which the shaft portion is inserted and the protrusion portions protruding in a radial direction of the shaft portion from the base portion and the restriction portion side engaging portion is provided at the base portion.

According to the present aspect, since the uneven ring includes the base portion into which the shaft portion is inserted and the protrusion portions protruding in the radial direction of the shaft portion from the base portion and the restriction portion side engaging portion is provided at the base portion, it is possible to provide the restriction portion side engaging portion without influence on disposition of the protrusion portions.

Note that the present aspect may be an aspect that is subordinate to the sixth aspect or the eighth aspect instead of being subordinate to the seventh aspect.

An eleventh aspect of the present disclosure is an aspect that is subordinate to the seventh aspect and in which the uneven ring includes a base portion into which the shaft portion is inserted and the protrusion portions protruding in a radial direction of the shaft portion from the base portion and the plurality of protrusion portions are the reference portion side engaging portion.

According to the present aspect, since the uneven ring includes the base portion into which the shaft portion is inserted and the protrusion portions protruding in the radial direction of the shaft portion from the base portion and the plurality of protrusion portions are the reference portion side engaging portions, dedicated reference portion side engaging portions do not need to be provided and an increase in cost of the uneven ring can be suppressed.

Note that the present aspect may be an aspect that is subordinate to the fifth aspect or the eighth aspect instead of being subordinate to the seventh aspect.

A twelfth aspect of the present disclosure is an aspect that is subordinate to the seventh aspect and in which the uneven ring includes a base portion into which the shaft portion is inserted and the protrusion portions protruding in a radial direction of the shaft portion from the base portion and the plurality of protrusion portions are the restriction portion side engaging portion.

According to the present aspect, since the uneven ring includes the base portion into which the shaft portion is inserted and the protrusion portions protruding in the radial direction of the shaft portion from the base portion and the plurality of protrusion portions are the restriction portion side engaging portions, dedicated restriction portion side engaging portions do not need to be provided and an increase in cost of the uneven ring can be suppressed.

Note that the present aspect may be an aspect that is subordinate to the sixth aspect or the eighth aspect instead of being subordinate to the seventh aspect.

A thirteenth aspect of the present disclosure is an aspect that is subordinate to the first aspect and in which the restriction portion is pressed in a second direction which is a direction opposite to the first direction.

According to the present aspect, since the restriction portion is pressed in the second direction which is a direction opposite to the first direction, the plurality of uneven rings are pressed against the reference portion and formation of gaps between the plurality of uneven rings is suppressed.

Note that the present aspect may be an aspect that is subordinate to any one of the second to twelfth aspects instead of the first aspect.

A fourteenth aspect of the present disclosure is an aspect that is subordinate to the first aspect and in which the plurality of uneven rings include a first uneven ring and a second uneven ring positioned closer to the side, to which the first direction extends, than the first uneven ring is, a plurality of protrusion portions of the first uneven ring and a plurality of protrusion portions of the second uneven ring are disposed at different positions in the circumferential direction, and the plurality of protrusion portions of the first uneven ring and the plurality of protrusion portions of the second uneven ring partially overlap with each other in the axial direction.

According to the present aspect, since the plurality of protrusion portions of the first uneven ring and the plurality of protrusion portions of the second uneven ring are disposed at different positions in the circumferential direction, it is possible to suppress formation of a noticeable line at the medium along the axial direction, that is, a medium width direction.

In addition, since the plurality of protrusion portions of the first uneven ring and the plurality of protrusion portions of the second uneven ring partially overlap with each other in the axial direction, it is possible to suppress formation of a noticeable line at the medium along a medium transportation direction.

Note that the present aspect may be an aspect that is subordinate to any one of the second to thirteenth aspects instead of the first aspect.

According to a fifteenth aspect of the present disclosure, there is provided a medium transportation device including the uneven roller that is described in any one of the first to fourteenth aspects and that is rotationally driven and a facing roller nipping, together with the uneven roller, a medium onto which liquid is discharged.

According to the present aspect, in the medium transportation device, an advantageous effect of any one of the first to fourteenth aspects described above can be obtained.

A sixteenth aspect of the present disclosure is an aspect that is subordinate to the fifteenth aspect and in which the medium transportation device further includes a heating unit heating the shaft portion.

According to the present aspect, since the medium transportation device further includes the heating unit heating the shaft portion, the drying of the medium can be performed with the uneven roller in addition to curl correction of the medium.

According to a seventeenth aspect of the present disclosure, there is provided a recording apparatus including a recording unit performing recording by discharging liquid onto a medium and the medium transportation device according to the fifteenth aspect that transports the medium on which the recording is performed by the recording unit.

According to the present aspect, in the recording apparatus, an advantageous effect of any one of the first to fourteenth aspects described above can be obtained.

According to an eighteenth aspect of the present disclosure, there is provided a post-processing apparatus directly or indirectly coupled to a recording apparatus performing recording by discharging liquid onto a medium, the post-processing apparatus including a post-processing unit performing post-processing on the medium on which the recording is performed by the recording apparatus and the medium transportation device according to the fifteenth aspect that transports, toward the post-processing unit, the medium on which the recording is performed by the recording apparatus.

According to the present aspect, in the post-processing apparatus, an advantageous effect of any one of the first to fourteenth aspects described above can be obtained.

According to a nineteenth aspect of the present disclosure, there is provided a relay apparatus that is disposed between a recording apparatus performing recording by discharging liquid onto a medium and a post-processing apparatus performing post-processing on the medium on which the recording is performed by the recording apparatus and that passes the medium from the recording apparatus to the post-processing apparatus, the relay apparatus including the medium transportation device according to the fifteenth aspect.

According to the present aspect, in the relay apparatus, an advantageous effect of any one of the first to fourteenth aspects described above can be obtained.

In addition, in the relay apparatus, since curl correction is performed by the uneven roller, the aligning property of the medium in the post-processing apparatus is improved and the precision of the post-processing is improved.

According to a twentieth aspect of the present disclosure, there is provided an uneven ring constituting an uneven roller of which a surface coming into contact with a medium, onto which liquid is discharged, is provided with a plurality of protrusions and recesses. The uneven ring is configured to be mounted on a shaft portion constituting the uneven roller and includes a plurality of protrusion portions disposed along a circumferential direction.

According to the present aspect, a plurality of protrusions are formed at the medium by the uneven roller, so that curl of the medium can be corrected. Here, since the uneven roller can be configured by mounting a plurality of the uneven rings on the shaft portion, it is possible to easily configure the uneven rollers having different specifications by changing the shape of the uneven ring with the shaft portion used as a common component and thus the cost of members can be reduced.

In addition, by changing the number of the uneven rings, it is possible to easily change the length of a region of the plurality of protrusions and recesses in the axial direction.

In addition, a job to be performed when wear or the like of a portion of the uneven roller occurs is simply replacing the uneven ring of a corresponding portion. Therefore, it is possible to suppress the required cost in comparison with the case of replacement of the entire uneven roller and to cope with requests for reuse and waste minimisation.

According to a twenty-first aspect of the present disclosure, there is provided a manufacturing method of an uneven roller of which a surface coming into contact with a medium, onto which liquid is discharged, is provided with a plurality of protrusions and recesses, the manufacturing method including mounting a reference portion on a shaft portion, forming a ring portion by repeatedly sliding an uneven ring, which includes a plurality of protrusion portions disposed along a circumferential direction, onto the shaft portion toward the reference portion a plurality of times, and mounting, onto the shaft portion, a restriction portion restricting movement of the ring portion in a direction away from the reference portion.

According to the present aspect, a plurality of protrusions are formed at the medium by the uneven roller, so that curl of the medium can be corrected. Here, since the ring portion of the uneven roller can be configured by mounting the plurality of uneven rings between the reference portion and the restriction portion, it is possible to easily configure the uneven rollers having different specifications by changing the shape of the uneven ring with the shaft portion used as a common component and thus the cost of members can be reduced.

In addition, by changing the number of the uneven rings, it is possible to easily change the length of the ring portion in the axial direction and to easily manufacture the uneven rollers having different dimensions.

In addition, a job to be performed when wear or the like of a portion of the ring portion occurs is simply replacing the uneven ring of a corresponding portion. Therefore, it is possible to suppress the required cost in comparison with the case of replacement of the entire uneven roller and to cope with requests for reuse and waste minimisation.

Hereinafter, the present disclosure will be specifically described.

In the XYZ coordinate system shown in each drawing, an X-axis direction is an apparatus depth direction, a Y-axis direction is an apparatus width direction, a Z-axis direction is an apparatus height direction. Among these, the X-axis direction is an axial direction of each of rollers constituting a transportation roller pair which will be described later.

### Overall Configuration of Recording System

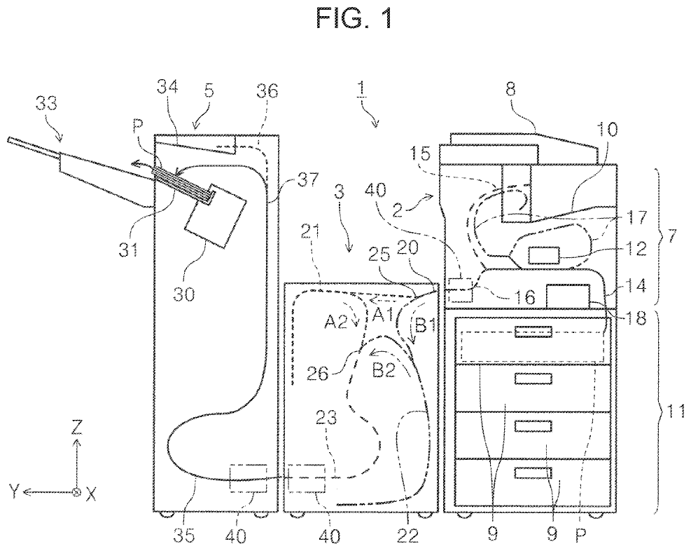

A recording system 1 shown in FIG. 1 includes, as an example, a recording apparatus 2, a relay apparatus 3, and a post-processing apparatus 5 arranged in this order from right to left in FIG. 1. Note that FIG. 1 is a front view, and a user can perform various work in front of the system. The recording apparatus 2 performs recording on a sheet-shaped medium P transported thereto. The relay apparatus 3 receives the medium P after the recording from the recording apparatus 2 and delivers the medium P to the post-processing apparatus 5. The post-processing apparatus 5 performs, on the received medium P, post-processing which is represented by binding processing. Hereinafter, the recording apparatus 2, the relay apparatus 3, and the post-processing apparatus 5 will be further described in this order.

The recording apparatus 2 is configured as a multifunction machine including a printer unit 7 that includes a line head 12, which serves as a recording unit that performs recording on the medium P, and a scanner unit 8 which is an example of an image reading device. In the present embodiment, the line head 12 is configured as a so-called ink jet recording head that discharges ink, which is liquid, onto the medium P to perform recording.

A cassette accommodation portion 11 including a plurality of medium accommodation cassettes 9 is provided below the printer unit 7. The medium P stored in the medium accommodation cassette 9 is sent to a recording region of the line head 12 through a feeding path 14, which is indicated by a solid line in FIG. 1, so that recording is performed thereon. The medium P after recording performed by the line head 12 is sent to any of a first discharge path 15 which is a path through which the medium P is discharged to an after-recording discharge tray 10 provided above the line head 12, a second discharge path 16 which is a path through which the medium P is sent to the relay apparatus 3, and an inversion path 17 in which the medium P is inverted so that recording is performed on a rear surface of the medium P.

Note that hereinafter, one surface of the medium P will be referred to as a “first surface S1”, and another surface will be referred to as a “second surface S2”. In addition, hereinafter, it will be assumed that recording is performed on the first surface S1 first and recording is performed on the second surface S2 after the medium P is inverted in the inversion path 17 when recording is to be performed on both surfaces of the medium P in the recording apparatus 2. Hereinafter, it will be assumed that recording is performed on both surfaces of the medium P, and a surface of the medium P on which recording is performed last is the second surface S2. However, when recording is performed on only one surface of the medium P, the first surface S1 is a surface on which recording is performed last.

In FIG. 1, the first discharge path 15 is indicated by a broken line, the second discharge path 16 is indicated by an one-dot chain line, and the inversion path 17 is indicated by a two-dot chain line.

Through the second discharge path 16, the medium P is delivered to a reception path 20 of the relay apparatus 3 which is adjacent thereto. In the inversion path 17, after recording is performed on the first surface S1 of the medium P, the medium P is inverted so that the second surface S2 faces the line head 12. Note that in each of the feeding path 14, the first discharge path 15, the second discharge path 16, and the inversion path 17, one or more roller pairs (not shown) are disposed as an example of a unit that transports the medium P.

The recording apparatus 2 is provided with a control unit 18 that controls operations related to transportation of the medium P in the recording apparatus 2 and recording. Note that the recording system 1 is configured such that the recording apparatus 2, the relay apparatus 3, and the post-processing apparatus 5 are mechanically and electrically coupled to each other and the medium P can be transported from the recording apparatus 2 to the post-processing apparatus 5. The control unit 18 can control various operations in the relay apparatus 3 and the post-processing apparatus 5 which are coupled to the recording apparatus 2.

In addition, the control unit 18 can control a medium transportation device 40 which will be described later.

The recording system 1 is configured such that settings of various operations in the recording apparatus 2, the relay apparatus 3, and the post-processing apparatus 5 can be input and an instruction for execution of the various operations can be given via an operation panel (not shown). The operation panel can be provided in the recording apparatus 2, for example.

Next, the relay apparatus 3 will be described. The relay apparatus 3 delivers, to the post-processing apparatus 5, the medium P received from the recording apparatus 2. The relay apparatus 3 is disposed between the recording apparatus 2 and the post-processing apparatus 5. The medium P transported through the second discharge path 16 of the recording apparatus 2 is received by the relay apparatus 3 through the reception path 20 and is transported toward the post-processing apparatus 5. The reception path 20 is indicated by a solid line in FIG. 1.

In the relay apparatus 3, the number of transportation paths for transportation of the medium P is two. The first transportation path is a path through which the medium P is transported from the reception path 20 to a confluence path 23 via a first switchback path 21 indicated by a dotted line in FIG. 1. The second path is a path through which the medium P is transported from the reception path 20 to the confluence path 23 via a second switchback path 22 indicated by a two-dot chain line. The first switchback path 21 is a path through which the medium P is received in a direction along an arrow A1 and the medium P is switched back in a direction along an arrow A2. The second switchback path 22 is a path through which the medium P is received in a direction along an arrow B1 and the medium P is switched back in a direction along an arrow B2. The reception path 20 branches into the first

switchback path 21 and the second switchback path 22 at a branching portion 25. The branching portion 25 is provided with a flap (not shown) that switches the destination of the medium P to any of the first switchback path 21 and the second switchback path 22.

In addition, the first switchback path 21 and the second switchback path 22 join each other at a junction portion 26. Therefore, regardless of whether the medium P from the reception path 20 is sent to the first switchback path 21 or the second switchback path 22, the medium P can be delivered to the post-processing apparatus 5 via the common confluence path 23.

The medium P transported through the confluence path 23 is delivered to a first transportation path 35 of the post-processing apparatus 5 from a side surface of the relay apparatus 3 in a +Y direction. Note that in each of the reception path 20, the first switchback path 21, the second switchback path 22, and the confluence path 23, one or more transportation roller pairs (not shown) are disposed as an example of a unit that transports the medium P.

When recording is consecutively performed on a plurality of the mediums P in the recording apparatus 2, the mediums P entering the relay apparatus 3 are alternately sent to the transportation path through the first switchback path 21 and the transportation path through the second switchback path 22. Therefore, medium transportation throughput in the relay apparatus 3 can be increased.

In addition, since the medium P on which recording is performed by the recording apparatus 2 is delivered from the recording apparatus 2 to the post-processing apparatus 5 via the relay apparatus 3, a transportation time taken for the medium P after the recording to be sent to the post-processing apparatus 5 can be lengthened and drying of the medium P can be promoted until the medium P reaches the post-processing apparatus 5.

However, in the recording system 1, the relay apparatus 3 may be omitted so that the post-processing apparatus 5 and the recording apparatus 2 are directly coupled to each other. That is, the post-processing apparatus 5 may be indirectly coupled to the recording apparatus 2 or be directly coupled to the recording apparatus 2.

Next, the post-processing apparatus 5 will be described. The post-processing apparatus 5 includes, as an example of a post-processing unit, a processing unit 30 that performs binding processing. The binding processing is, for example, processing of binding one corner portions of the mediums P or one sides of the mediums P. That is, in the present embodiment, the processing unit 30 is a stapler that performs the binding processing of piling the plurality of mediums P and binding end portions thereof. Note that the processing unit 30 is not limited thereto and may be configured to perform other processing such as punching processing of punching a hole at a predetermined position in the medium P.

The post-processing apparatus 5 includes the first transportation path 35 that leads to the processing unit 30. That is, the medium P received by the post-processing apparatus 5 is transported through the first transportation path 35 indicated by a solid line in FIG. 1. The mediums P transported through the first transportation path 35 are sent to a processing tray 31 and stacked on the processing tray 31 with trailing ends thereof in a transportation direction aligned with each other. When a predetermined number of the mediums P are stacked on the processing tray 31, the binding processing is performed by the processing unit 30.

The mediums P processed by the processing unit 30 are discharged toward a main tray 33 by a discharge unit (not shown).

A second transportation path 36, which branches off from the first transportation path 35 at a branching portion 37, is coupled to the first transportation path 35. The second transportation path 36 is a path through which the medium P is discharged to an upper tray 34 provided at an upper portion of the post-processing apparatus 5. On the upper tray 34, the mediums P that are not to be processed can be stacked.

In each of the first transportation path 35 and the second transportation path 36, one or more pairs of rollers (not shown) are disposed as an example of a unit that transports the medium P. In addition, the branching portion 37 is provided with a flap (not shown) that switches the destination of the medium P.

In the recording system 1 described above, at least one of the recording apparatus 2, the relay apparatus 3, and the post-processing apparatus 5 is provided with the medium transportation device 40. In FIG. 1, each of the recording apparatus 2, the relay apparatus 3, and the post-processing apparatus 5 includes one medium transportation device 40. However, at least one of the recording apparatus 2, the relay apparatus 3, and the post-processing apparatus 5 may be provided with the medium transportation device 40. In addition, the recording apparatus 2, the relay apparatus 3, and the post-processing apparatus 5 may be provided with a plurality of the medium transportation devices 40. In addition, a position where the medium transportation device 40 is provided in the recording apparatus 2, the relay apparatus 3, and the post-processing apparatus 5 is not limited to a position shown in FIG. 1 and the medium transportation device 40 may be provided at another position.

The medium transportation device 40 has a function of correcting a curl of the medium P, and can also be referred to as a curl correction device from this viewpoint.

The medium transportation device 40 corrects a curl of the medium P with a transportation roller pair 41 which will be described later. However, a device to which the transportation roller pair 41 can be detachably attached and that is in a state where the transportation roller pair 41 is not mounted therein may also be used as the medium transportation device 40.

In addition, when the recording apparatus 2, the relay apparatus 3, or the post-processing apparatus 5 is provided with the medium transportation device 40, a device to which the medium transportation device 40 can be detachably attached and that is in a state where the medium transportation device 40 is not mounted therein may also be used as the recording apparatus 2, the relay apparatus 3, or the post-processing apparatus 5.

When the recording apparatus 2 includes the medium transportation device 40, the medium transportation device 40 is provided in the second discharge path 16 as shown in FIG. 1, for example. According to such a configuration, a curl of the medium P can be corrected before the medium P on which recording is finished is transported to the relay apparatus 3 or the post-processing apparatus 5.

When the relay apparatus 3 includes the medium transportation device 40, the medium transportation device 40 is provided in the confluence path 23 as shown in FIG. 1, for example. According to such a configuration, a curl of the medium P can be corrected before the medium P is transported to the post-processing apparatus 5 even when the medium transportation device 40 is not provided for each of the switchback paths 21 and 22.

When the post-processing apparatus 5 includes the medium transportation device 40, the medium transportation device 40 is provided in the first transportation path 35 as shown in FIG. 1, for example. According to such a configuration, a curl of the medium P can be corrected before the medium P on which recording is finished is transported to the processing unit 30.

Note that there are a plurality of embodiments of the medium transportation device 40. Hereinafter, each of the embodiments of the medium transportation device will be referred to as, for example, a medium transportation device 40A or the like with a capital alphabet letter added to the reference numeral “40”. In addition, when it is not necessary to distinguish the embodiments of the medium transportation device from each other, the embodiments will be collectively referred to as the medium transportation devices 40. Note that repetitive description about the common features between the embodiments will not be made. In addition, the action and effect described in one of the embodiments can also be achieved in the other embodiments regarding the technically common features therebetween.

In addition, there are also a plurality of embodiments of components of the medium transportation device 40 which will be described later and when a capital alphabet letter is added to a number of the reference numeral of a component of the medium transportation device 40, the reference numeral with the capital alphabet letter added thereto represents one of the embodiments. In addition, when the reference numeral of a component of the medium transportation device 40 is described with a number only, the reference numeral collectively means a plurality of embodiments thereof distinguishing therebetween. For example, in the case of the transportation roller pair 41 which will be described later, an expression “transportation roller pair 41” alone means a plurality of embodiments thereof without distinguishing therebetween. In addition, for example, an expression “transportation roller pair 41A” means one of the embodiments. Note that repetitive description about the common features between the embodiments will not be made. In addition, the action and effect described in one of the embodiments can also be achieved in the other embodiments regarding the technically common features therebetween.

### Basic Principle of Curl Correction in Medium Transportation Device

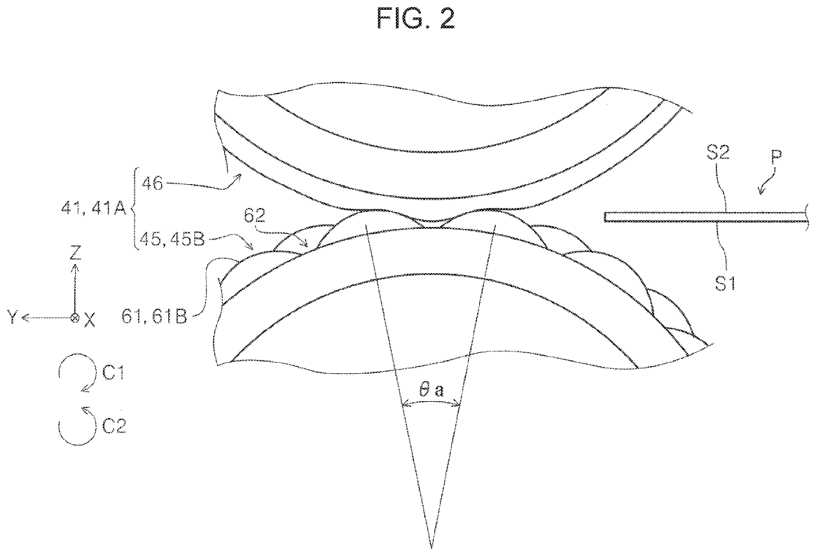

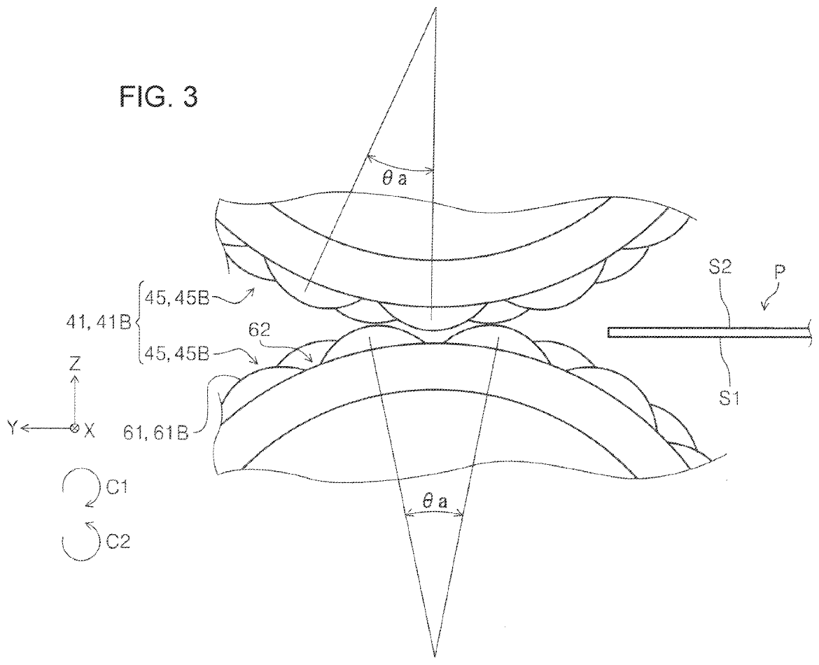

A basic principle of curl correction in the medium transportation device 40 will be described with reference to FIGS. 2 and 3.

The medium transportation device 40 corrects a curl of the medium P by causing the medium P to be nipped by the transportation roller pair 41 including two rollers facing each other. Both or one of the two rollers facing each other is an uneven roller 45, and the medium P is nipped by the transportation roller pair 41 including the uneven roller 45 so that the curl of the medium is corrected. The uneven roller 45 includes a plurality of protrusion portions 61 that are formed along a circumferential direction and an axial direction and gaps between the plurality of protrusion portions 61 in the circumferential direction and the axial direction are recess portions 62. That is, a surface of the uneven roller 45 that comes into contact with the medium P is provided with a plurality of protrusions and recesses.

At a predetermined position in the axial direction of the uneven roller 45, the protrusion portions 61 are disposed at pitches ea in the circumferential direction.

When only one of the two rollers facing each other is the uneven roller 45 in the present embodiment, the uneven roller 45 is driven by a motor. In addition, when both of the two rollers facing each other are the uneven rollers 45, the two uneven rollers 45 are coupled to each other by a gear and then are rotationally driven in synchronization. However, the present disclosure is not limited to such a driving method.

FIG. 2 is an example of the transportation roller pair 41 in which only one of the two rollers facing each other is the uneven roller 45 and is an enlarged view showing a nip region of a transportation roller pair 41A in which one facing roller is the uneven roller 45 and another facing roller is an elastic roller 46. Note that in FIG. 2, the first surface S1 of the medium P comes into contact with the uneven roller 45. However, such a configuration is merely an example and the second surface S2 may come into contact with the uneven roller 45.

The elastic roller 46 is formed of, for example, sponge and can be elastically deformed when coming into contact with the protrusions and recesses of the uneven roller 45. The uneven roller 45 is driven in a rotation direction C2 by a motor and the elastic roller 46 is driven to rotate in a rotation direction C1.

A curl of the medium P is corrected when the medium P is nipped by the uneven roller 45 and the elastic roller 46.

FIG. 3 is an example of the transportation roller pair 41 in which both of the two rollers facing each other are the uneven rollers 45 and is an enlarged view showing a nip region of a transportation roller pair 41B in which both of the two rollers facing each other are the uneven rollers 45. The uneven roller 45 on a lower side is driven in the rotation direction C2 by a motor and the uneven roller 45 on an upper side is driven in the rotation direction C1 by a motor.

A curl of the medium P is corrected when the medium P is nipped by the two uneven rollers 45.

### Configuration and Manufacturing Method of Uneven Roller

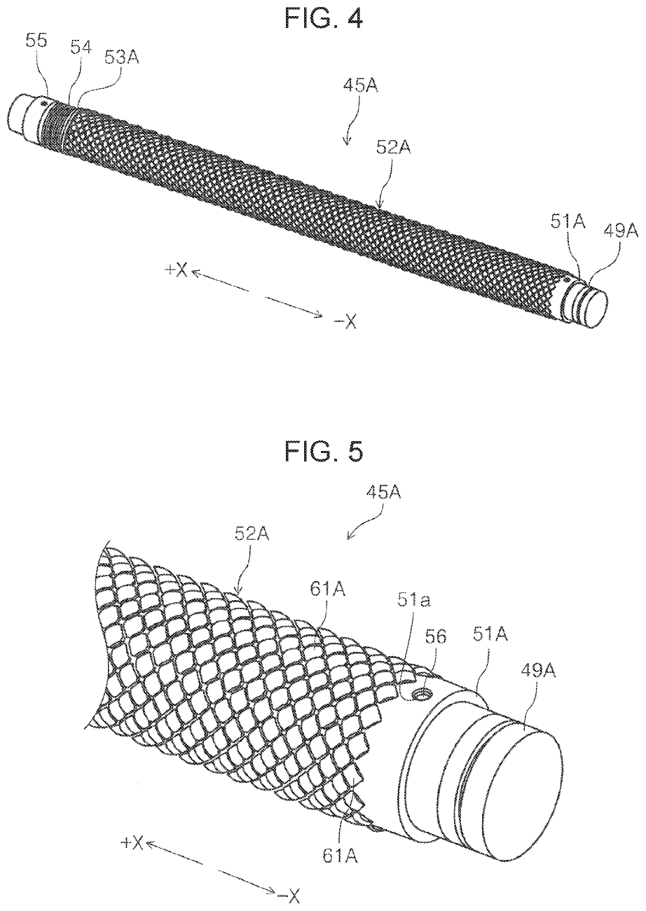

Next, a configuration of the uneven roller 45 and a manufacturing method thereof will be described with reference to FIGS. 4 to 13.

The axial direction of the uneven roller 45 is the X-axis direction in all of embodiments which will be described below. Regarding the X-axis direction, a +X direction is an example of a first direction, and a −X direction is an example of a second direction.

The uneven roller 45 includes a shaft portion 49, a reference portion 51 mounted on the shaft portion 49, a ring portion 52 that is positioned closer to a side, to which the +X direction extends, than the reference portion 51 is and that is mounted on the shaft portion 49, and a restriction portion 53 that is positioned closer to the side, to which the +X direction extends, than the ring portion 52 is and that is mounted on the shaft portion 49 to restrict movement of the ring portion 52 in the +X direction. In addition, the ring portion 52 is composed of a plurality of uneven rings 60 disposed along the axial direction, the uneven ring 60 including a plurality of the protrusion portions 61 disposed along the circumferential direction.

In the present embodiment, the shaft portion 49 is formed of metal.

In addition, in the present embodiment, the reference portion 51 is formed of resin. For example, the reference portion 51 is formed of polyoxymethylene (POM). The reference portion 51 is a cylindrical member, has an inner diameter slightly larger than the outer diameter of the shaft portion 49, and is formed to be slidable along the axial direction and not to wobble in a radial direction when being slid onto the shaft portion 49.

In addition, in the present embodiment, the restriction portion 53 is formed of resin. For example, the restriction portion 53 is formed of polyoxymethylene (POM). The restriction portion 53 is a cylindrical member, has an inner diameter slightly larger than the outer diameter of the shaft portion 49, and is formed to be slidable along the axial direction and not to wobble in the radial direction when being slid onto the shaft portion 49.

In addition, in the present embodiment, the uneven ring 60 is formed of resin. For example, the uneven ring 60 is formed of polyoxymethylene (POM). The uneven ring 60 has an inner diameter slightly larger than the outer diameter of the shaft portion 49 and is formed to be slidable along the axial direction and not to wobble in the radial direction when being slid onto the shaft portion 49.

Hereinafter, a configuration and a manufacturing method of an uneven roller 45A, which is an embodiment of the uneven roller 45, will be described. The uneven roller 45A is a roller with a roller surface having a higher protrusion and recess density than an uneven roller 45B which will be described later.

The uneven roller 45A includes a shaft portion 49A, a reference portion 51A mounted on the shaft portion 49A, a ring portion 52A that is positioned closer to a side, to which the +X direction extends, than the reference portion 51A is and that is mounted on the shaft portion 49A, and a restriction portion 53A that is positioned closer to the side, to which the +X direction extends, than the ring portion 52A is and that is mounted on the shaft portion 49A to restrict movement of the ring portion 52A in the +X direction. Furthermore, the uneven roller 45A includes a spring 54 that presses the restriction portion 53A in the −X direction and a stopper 55 that restricts movement of the spring 54 in the +X direction.

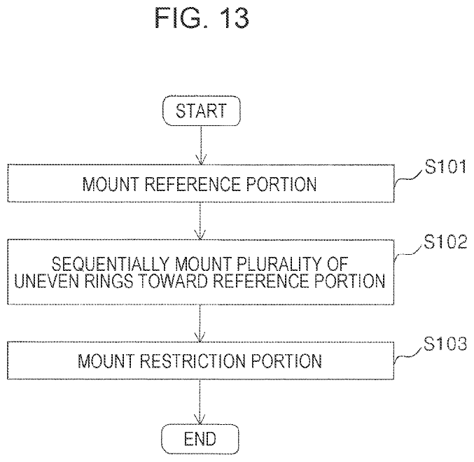

A method of manufacturing the uneven roller 45A includes steps S101, S102, and S103 shown in FIG. 13. Step S101 is a step of mounting the reference portion 51A onto the shaft portion 49A. Step S102 is a step of forming the ring portion 52A by repeating a step of sliding an uneven ring 60A, which includes a plurality of protrusion portions 61A disposed along the circumferential direction, onto the shaft portion 49A toward the reference portion 51A a plurality of times. Step S103 is a step of mounting, onto the shaft portion 49A, the restriction portion 53A that restricts movement of the ring portion 52A in a direction away from the reference portion 51A.

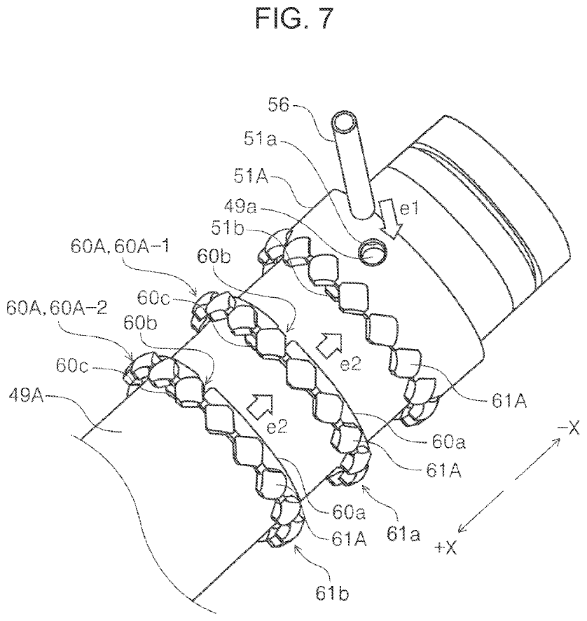

As shown in FIGS. 5, 7, and 8, a hole 51a is formed at the reference portion 51A, and a hole 49a is formed at the shaft portion 49A. The reference portion 51A is slid onto the shaft portion 49A, and then a fixation pin 56 is press-fitted into the hole 51a and the hole 49a as indicated by an arrow e1 in FIG. 7 in a state where the hole 51a coincides with the hole 49a. Accordingly, the reference portion 51A is fixed so as not to move in the axial direction and the circumferential direction with respect to the shaft portion 49A.

As described above, the manufacturing of the uneven roller 45A includes a first step (the step S101 in FIG. 13) of mounting the reference portion 51A onto the shaft portion 49A and fixing the reference portion 51A.

Note that a method of fixing the reference portion 51A with respect to the shaft portion 49A is not limited to a method of press-fitting the fixation pin 56 and may be other fixing methods such as a screw-fixing method or an adhesion-fixing method, for example.

As a second step (the step S102 in FIG. 13) after the first step, the ring portion 52A is formed. The ring portion 52A is formed by sequentially sliding a plurality of the uneven rings 60A in the −X direction, that is, toward the reference portion 51A as indicated by arrows e2 in FIG. 7.

Here, at the reference portion 51A, the plurality of protrusion portions 61A are provided along the circumferential direction on a side to which the +X direction extends, that is, on a side on which the reference portion 51A engages with the uneven rings 60A. The reference portion 51A is provided with one protrusion portion row composed of the plurality of protrusion portions 61A disposed along the circumferential direction. A ring engagement projection 51b protruding in the +X direction is formed between some of the protrusion portions 61A adjacent to each other in the circumferential direction.

Note that the reference portion 51A may not be provided with the protrusion portions 61A.

The uneven ring 60A includes a ring-shaped base portion 60a that is fitted to the shaft portion 49A. The base portion 60a is provided with the plurality of protrusion portions 61A disposed along the circumferential direction. The uneven ring 60A is provided with one protrusion portion row composed of the plurality of protrusion portions 61A disposed along the circumferential direction. The protrusion portions 61A of the uneven ring 60A are provided to protrude in the +X direction with respect to the base portion 60a.

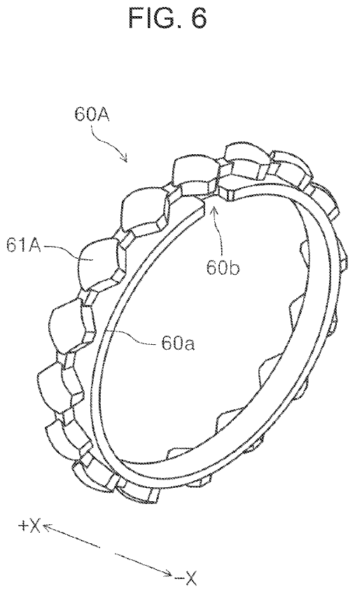

In addition, at a position where one protrusion portion 61A is disposed in the circumferential direction, a reference portion side engaging portion 60b that is open in the −X direction is formed at the base portion 60a (refer to FIG. 6 as well) and the ring engagement projection 51b of the reference portion 51A can be fitted to the reference portion side engaging portion 60b.

When the reference portion side engaging portion 60b and the ring engagement projection 51b are fitted to each other, the protrusion portion 61A of the uneven ring 60A enters a space between two protrusion portions 61A of the reference portion 51A that are adjacent to each other in the circumferential direction. In other words, when the reference portion side engaging portion 60b and the ring engagement projection 51b are fitted to each other, the protrusion portion 61A of the reference portion 51A enters a space between two protrusion portions 61A of the uneven ring 60A that are adjacent to each other in the circumferential direction. That is, in an assembled state, the protrusion portion 61A of the reference portion 51A and the protrusion portion 61A of the uneven ring 60A adjacent to the reference portion 51A are disposed at different positions in the circumferential direction.

The positions of the reference portion side engaging portion 60b and the ring engagement projection 51b in the circumferential direction are set such that the protrusion portions 61A can fit into each other as described above.

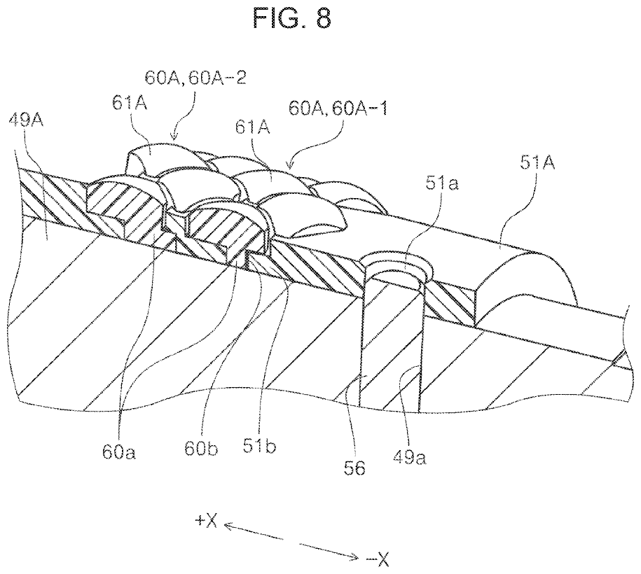

Note that in a state where the reference portion side engaging portion 60b and the ring engagement projection 51b are fitted to each other, the ring engagement projection 51b is in a state of being in a space below one protrusion portion 61A constituting the uneven ring 60A as shown in FIG. 8.

In addition, at the base portion 60a of the uneven ring 60A, a restriction portion side engaging portion 60c protruding in the +X direction is formed between some of the protrusion portions 61A adjacent to each other in the circumferential direction. In addition, the restriction portion side engaging portion 60c can be fitted to the reference portion side engaging portion 60b of the uneven ring 60A adjacent thereto.

Accordingly, the reference portion side engaging portion 60b can be used not only for the positioning of the uneven ring 60A with respect to the reference portion 51A but also for the positioning of the uneven rings 60A that are adjacent to each other. In addition, the restriction portion side engaging portion 60c can be used not only for the positioning of the uneven rings 60A that are adjacent to each other but also for the positioning of the uneven ring 60A with respect to the restriction portion 53A which will be described later.

When two uneven rings 60A adjacent to each other are fitted to each other, the protrusion portion 61A of one of the uneven rings 60A enters a space between two protrusion portions 61A of another uneven ring 60A. When an uneven ring indicated by a reference numeral “60A-1” in FIG. 7 is referred to as a first uneven ring and an uneven ring indicated by a reference numeral “60A-2” is referred to as a second uneven ring, the protrusion portion 61A of a second uneven ring 60A-2 enters a space between two adjacent protrusion portions 61A of a first uneven ring 60A-1.

In other words, the protrusion portion 61A of the first uneven ring 60A-1 enters a space between two adjacent projection portions 61A of the second uneven ring 60A-2. That is, in the assembled state, the protrusion portion 61A of the first uneven ring 60A-1 and the protrusion portion 61A of the second uneven ring 60A-2 are disposed at different positions in the circumferential direction.

In FIG. 7, a reference numeral “61a” indicates a first protrusion portion row composed of the protrusion portions 61A of the first uneven ring 60A-1 and a reference numeral “61b” indicates a second protrusion portion row composed of the protrusion portions 61A of the second uneven ring 60A-2. The protrusion portions 61A of a first protrusion portion row 61a and the protrusion portions 61A of a second protrusion portion row 61b are disposed at different positions in the circumferential direction.

The positions of the reference portion side engaging portion 60b and the restriction portion side engaging portion 60c in the circumferential direction are set such that the protrusion portions 61A can fit into each other as described above.

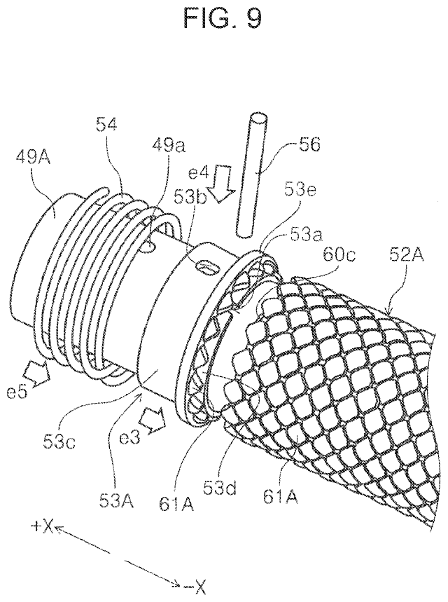

As a third step (the step S103 in FIG. 13) after the second step of forming the ring portion 52A, the restriction portion 53A is slid onto the shaft portion 49A as indicated by an arrow e3 in FIG. 9 and then fixed.

The restriction portion 53A includes a cylindrical first base portion 53c, which is closer to the side, to which the +X direction extends, than a flange portion 53e having the largest outer diameter is, and a cylindrical second base portion 53d, which is closer to the side, to which the −X direction extends, than the flange portion 53e is.

A long hole 53b is formed at the first base portion 53c. The long hole 53b is a hole extending in the X-axis direction, that is, in the axial direction. In addition, a hole (not shown) into which the fixation pin 56 can be press-fitted is formed at the shaft portion 49A.

In a state where the restriction portion 53A is slid onto the shaft portion 49A and the long hole 53b and the hole of the shaft portion 49A coincide with each other, the fixation pin 56 is press-fitted as indicated by an arrow e4 in FIG. 9. Accordingly, the restriction portion 53A is fixed so as not to move in the circumferential direction with respect to the shaft portion 49A.

However, since the long hole 53b is a long hole that is long in the axial direction and the width of the long hole 53b in the circumferential direction is slightly larger than that of the fixation pin 56, the restriction portion 53A is in a state of being slidable in the X-axis direction within a formation range of the long hole 53b.

Here, a plurality of the protrusion portions 61A are provided along the circumferential direction on a side closer to a side, to which the −X direction extends, than the flange portion 53e is, that is, on a side on which the restriction portion 53A engages with the uneven rings 60A. Note that the protrusion portion 61A provided at the restriction portion 53A has a shape obtained when removing the half of the protrusion portion 61A of the uneven ring 60A in the axial direction.

The restriction portion 53A is provided with one protrusion portion row composed of the plurality of protrusion portions 61A disposed along the circumferential direction. At a position where one protrusion portion 61A is disposed in the circumferential direction, a ring engagement recess portion 53a that is open in the −X direction is formed at the second base portion 53d and the restriction portion side engaging portion 60c of the uneven ring 60A can be fitted to the ring engagement recess portion 53a.

Note that the restriction portion 53A may not be provided with the protrusion portions 61A.

When the ring engagement recess portion 53a and the restriction portion side engaging portion 60c are fitted to each other, the protrusion portion 61A of the uneven ring 60A enters a space between two protrusion portions 61A of the restriction portion 53A that are adjacent to each other in the circumferential direction. In other words, when the ring engagement recess portion 53a and the restriction portion side engaging portion 60c are fitted to each other, the protrusion portion 61A of the restriction portion 53A enters a space between two protrusion portions 61A of the uneven ring 60A that are adjacent to each other in the circumferential direction. That is, in the assembled state, the protrusion portion 61A of the restriction portion 53A and the protrusion portion 61A of the uneven ring 60A adjacent to the restriction portion 53A are disposed at different positions in the circumferential direction.

The positions of the ring engagement recess portion 53a and the restriction portion side engaging portion 60c in the circumferential direction are set such that the protrusion portions 61A can fit into each other as described above.

Note that in a state where the ring engagement recess portion 53a and the restriction portion side engaging portion 60c are fitted to each other, the second base portion 53d is in a state of being in a space below the protrusion portions 61A constituting the uneven ring 60A.

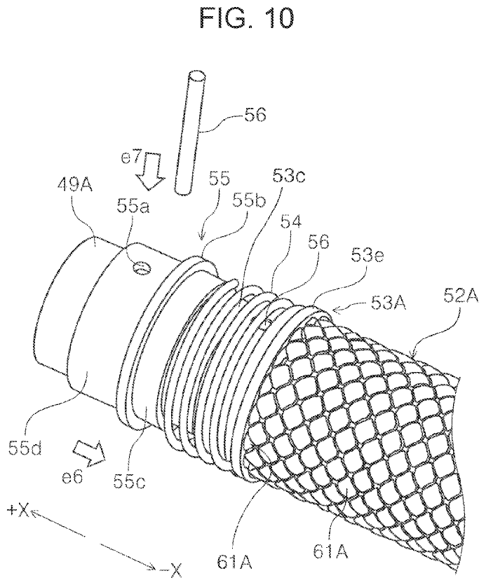

Next, as a fourth step, a compression spring 54, which is an example of a pressing member, is slid onto the shaft portion 49A as indicated by an arrow e5 in FIG. 9 and then fitted to the first base portion 53c of the restriction portion 53A as shown in FIG. 10. Note that the inner diameter of the compression spring 54 is larger than the outer diameter of the first base portion 53c.

Next, as a fifth step, the stopper 55 is slid onto the shaft portion 49A as indicated by an arrow e6 in FIG. 10 and then fixed. The stopper 55 includes a cylindrical first base portion 55d, which is closer to the side, to which the +X direction extends, than a flange portion 55b having the largest outer diameter is, and a cylindrical second base portion 55c, which is closer to the side, to which the −X direction extends, than the flange portion 55b is.

A hole 55a is formed at the first base portion 55d. In addition, a hole (not shown) into which the fixation pin 56 can be press-fitted is formed at the shaft portion 49A.

In a state where the stopper 55 is slid onto the shaft portion 49A and the hole 55a and the hole of the shaft portion 49A coincide with each other, the fixation pin 56 is press-fitted as indicated by an arrow e7. Accordingly, the stopper 55 is fixed so as not to move in the axial direction and the circumferential direction with respect to the shaft portion 49A.

Here, since the inner diameter of the compression spring 54 is larger than the outer diameter of the second base portion 55c, the second base portion 55c enters the inside of the compression spring 54.

In addition, the outer diameters of the flange portion 53e of the restriction portion 53A and the flange portion 55b of the stopper 55 are larger than the inner diameter of the compression spring 54 and the free length of the compression spring 54 is larger than a distance between the flange portion 53e of the restriction portion 53A and the flange portion 55b of the stopper 55 in the axial direction. Therefore, the compression spring 54 applies a pressing force in the −X direction to the flange portion 53e of the restriction portion 53A.

Accordingly, the plurality of uneven rings 60A constituting the ring portion 52A are pressed toward the reference portion 51A in the −X direction and there is no wobbling between two uneven rings 60A that are adjacent to each other between the reference portion 51A and the restriction portion 53A.

The uneven roller 45A described above has a configuration in which the protrusion portions 61A overlap with each other in the axial direction. However, a configuration in which the protrusion portions 61A do not overlap with each other in the axial direction may also be adopted.

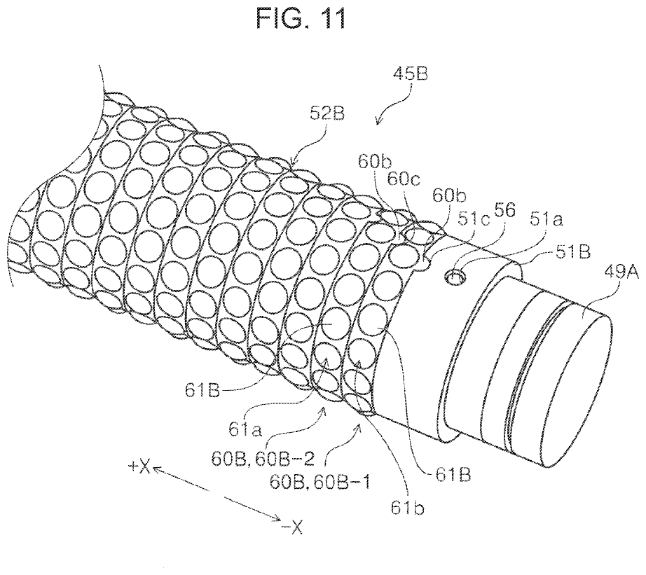

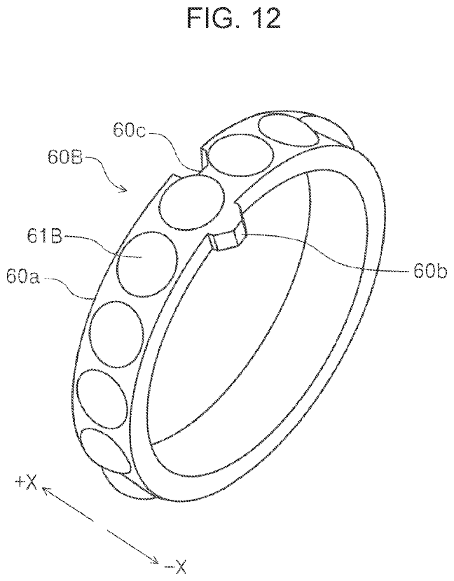

FIG. 11 shows the uneven roller 45B configured in such a manner, and a ring portion 52B is composed of a plurality of uneven rings 60B.

As shown in FIG. 12, the uneven ring 60B includes the ring-shaped base portion 60a that is fitted to the shaft portion 49A. The base portion 60a is provided with a plurality of protrusion portions 61B disposed along the circumferential direction. The uneven ring 60B is provided with one protrusion portion row composed of the plurality of protrusion portions 61B disposed along the circumferential direction.

In addition, at a position where one protrusion portion 61B is disposed in the circumferential direction, the reference portion side engaging portion 60b that protrudes in the −X direction is formed at the base portion 60a and the reference portion side engaging portion 60b can be fitted to a ring engagement recess portion 51c (refer to FIG. 11) of a reference portion 51B.

In addition, the restriction portion side engaging portion 60c that is open in the +X direction is formed between some of the protrusion portions 61B adjacent to each other in the circumferential direction at the base portion 60a and the reference portion side engaging portion 60b of the uneven ring 60B adjacent to the restriction portion side engaging portion 60c can be fitted to the restriction portion side engaging portion 60c.

Accordingly, the reference portion side engaging portion 60b can be used not only engagement with respect to the reference portion 51B but also for the positioning of the uneven rings 60B that are adjacent to each other. In addition, the restriction portion side engaging portion 60c is also used for the positioning of the uneven ring 60B with respect to the restriction portion 53 (not shown) corresponding to the above-described restriction portion 53A.

Note that unlike the above-described uneven ring 60A, the reference portion side engaging portion 60b of the uneven ring 60B is formed in a protruding shape and the restriction portion side engaging portion 60c of the uneven ring 60B is formed in a recessed shape. However, the reference portion side engaging portion 60b of the uneven ring 60B may also be formed in a recessed shape and the restriction portion side engaging portion 60c of the uneven ring 60B may also be formed in a protruding shape.

When two uneven rings 60B adjacent to each other are fitted to each other, the protrusion portion 61B of one uneven ring 60B and the protrusion portion 61B of another uneven ring 60B are disposed at different positions in the circumferential direction. When an uneven ring indicated by a reference numeral “60B-1” in FIG. 11 is referred to as a first uneven ring and an uneven ring indicated by a reference numeral “60B-2” is referred to as a second uneven ring, the protrusion portion 61B of a first uneven ring 60B-1 and the protrusion portion 61B of the second uneven ring 60B-2 are disposed at different positions in the circumferential direction.

The positions of the reference portion side engaging portion 60b and the restriction portion side engaging portion 60c in the circumferential direction are set such that the protrusion portions 61B are disposed as described above.

As described above, the uneven roller 45 includes the shaft portion 49, the reference portion 51 mounted on the shaft portion 49, the ring portion 52 that is positioned closer to the side, to which the +X direction extends, than the reference portion 51 is and that is mounted on the shaft portion 49, and the restriction portion 53 that is positioned closer to the side, to which the +X direction extends, than the ring portion 52 is and that is mounted on the shaft portion 49 to restrict movement of the ring portion 52 in the +X direction. In addition, the ring portion 52 is composed of a plurality of the uneven rings 60 disposed along the axial direction, the uneven ring 60 including the plurality of protrusion portions 61 along the circumferential direction.

In addition, the uneven ring 60 is an uneven ring constituting the uneven roller 45 of which a surface coming into contact with the medium P is provided with a plurality of protrusions and recesses and can be mounted onto the shaft portion 49 constituting the uneven roller 45.

In addition, the manufacturing method of the uneven roller 45 includes a step (the step S101 in FIG. 13) of mounting the reference portion 51 onto the shaft portion 49, a step (the step S102 in FIG. 13) of forming the ring portion 52 by repeating a step of sliding the uneven ring 60, which includes the plurality of protrusion portions 61 disposed along the circumferential direction, onto the shaft portion 49 toward the reference portion 51 a plurality of times, and a step (the step S103 in FIG. 13) of mounting, onto the shaft portion 49, the restriction portion 53 that restricts movement of the ring portion 52 in a direction away from the reference portion 51.

Therefore, by changing the shape of the uneven ring 60 with the shaft portion 49 used as a common component, it is possible to easily configure the uneven rollers 45 having different specifications, and the cost of members can be reduced.

In addition, by changing the number of the uneven rings 60, it is possible to easily change the length of the ring portion 52 in the axial direction and to easily manufacture the uneven rollers 45 having different dimensions.

In addition, a job to be performed when wear or the like of a portion of the ring portion 52 occurs is simply replacing the uneven ring 60 of a corresponding portion. Therefore, it is possible to suppress the required cost in comparison with the case of replacement of the entire uneven roller 45 and to cope with requests for reuse and waste minimisation.

Note that when the uneven ring 60 is worn, the worn uneven ring 60 may be replaced with a new uneven ring or the worn uneven ring 60 of one uneven roller 45 may be replaced with the uneven ring 60 that is not worn so much.

In addition, in the above-described embodiment, the reference portion 51 and the shaft portion 49 are configured as separate members. However, the reference portion 51 and the shaft portion 49 may be configured to be integrated with each other.

In addition, the ring portion 52 may not be composed of the uneven rings 60 only and the ring portion 52 may include, for example, a flat ring of which an outer peripheral surface is flat. In such a case, it is preferable that the outermost diameter of the flat ring is smaller than the outermost diameter of the uneven ring 60. Note that an example of the flat ring will be described later as a facing ring 63.

In addition, regarding the uneven roller 45, the plurality of uneven rings 60 that constitute the ring portion 52 have the same shape as each other. Accordingly, it is possible to suppress the cost of the uneven rings 60. Note that the ring portion 52 may be composed of a plurality of types of uneven rings 60 having different shapes.

In addition, regarding uneven roller 45, the plurality of protrusion portions 61 of the uneven ring 60 are arranged in a row in the circumferential direction. Accordingly, the width of the uneven ring 60 can be reduced and the length of the ring portion 52 in the axial direction can be adjusted more easily.

However, the uneven ring 60 may be provided with the plurality of protrusion portions 61 disposed in the axial direction.

In addition, two adjacent uneven rings 60 of the uneven roller 45 can engage with each other. Accordingly, the two adjacent uneven rings 60 can be restrained from rotating relative to each other such that the phases thereof are made offset from each other.

In addition, regarding the uneven roller 45, the uneven ring 60 includes the reference portion side engaging portion 60b that can engage with the reference portion 51. Accordingly, the uneven ring 60 that is adjacent to the reference portion 51 and the reference portion 51 can be restrained from rotating relative to each other such that the phases thereof are made offset from each other.

Note that the reference portion side engaging portion 60b does not need to be provided for all of the plurality of uneven rings 60 and the reference portion side engaging portion 60b may be provided only for the uneven ring 60 adjacent to the reference portion 51.

In addition, regarding the uneven roller 45, the uneven ring 60 includes the restriction portion side engaging portion 60c that can engage with the restriction portion 53. Accordingly, the uneven ring 60 that is adjacent to the restriction portion 53 and the restriction portion 53 can be restrained from rotating relative to each other such that the phases thereof are made offset from each other.

Note that the restriction portion side engaging portion 60c does not need to be provided for all of the plurality of uneven rings 60 and the restriction portion side engaging portion 60c may be provided only for the uneven ring 60 adjacent to the restriction portion 53.

In addition, regarding the uneven roller 45, the reference portion side engaging portion 60b and the restriction portion side engaging portion 60c can engage with each other. Accordingly, it is not necessary to provide a configuration for the positioning of the uneven rings 60 and thus the configuration can be simplified. However, the present disclosure is not limited to such a configuration, and a configuration in which the reference portion side engaging portion 60b and the restriction portion side engaging portion 60c cannot engage with each other may also be adopted.

In addition, regarding the uneven roller 45, the protrusion portions 61 of one uneven ring 60 and the protrusion portions 61 of the uneven ring 60 that is adjacent to the one uneven ring 60 are disposed at different positions in the circumferential direction. Accordingly, it is possible to suppress formation of a noticeable line at the medium P along the axial direction, that is, a medium width direction.

In addition, regarding the uneven roller 45, the uneven ring 60 includes the base portion 60a into which the shaft portion 49 is inserted and the protrusion portions 61 that protrude in a radial direction of the shaft portion 49 from the base portion 60a and the reference portion side engaging portion 60b is provided at the base portion 60a. Therefore, it is possible to provide the reference portion side engaging portion 60b without influence on disposition of the protrusion portions 61.

In addition, regarding the uneven roller 45, the restriction portion side engaging portion 60c of the uneven ring 60 is provided at the base portion 60a. Therefore, it is possible to provide the restriction portion side engaging portion 60c without influence on disposition of the protrusion portions 61.

Note that regarding the uneven roller 45A shown in FIGS. 4 to 10, the plurality of protrusion portion 61A may be configured to function as the reference portion side engaging portion 60b. That is, since the protrusion portions 61A of the reference portion 51A and the protrusion portions 61A of the uneven ring 60A of the uneven roller 45A fit into each other alternating in the circumferential direction, the uneven ring 60A adjacent to the reference portion 51A and the reference portion 51A can be restrained from rotating relative to each other such that the phases thereof are made offset from each other. That is, the plurality of protrusion portions 61A can function as the reference portion side engaging portion 60b. According to such a configuration, the reference portion side engaging portion 60b can be omitted, and an increase in cost of the uneven ring 60A can be suppressed.

Similarly, regarding the uneven roller 45A, the plurality of protrusion portion 61A may be configured to function as the restriction portion side engaging portion 60c. That is, since the protrusion portions 61A of the restriction portion 53A and the protrusion portions 61A of the uneven ring 60A of the uneven roller 45A fit into each other alternating in the circumferential direction, the uneven ring 60A adjacent to the restriction portion 53A and the restriction portion 53A can be restrained from rotating relative to each other such that the phases thereof are made offset from each other. That is, the plurality of protrusion portions 61A can function as the restriction portion side engaging portion 60c. According to such a configuration, the restriction portion side engaging portion 60c can be omitted, and an increase in cost of the uneven ring 60A can be suppressed.

In addition, regarding the uneven roller 45, since the restriction portion 53 is pressed in the −X direction, the plurality of uneven rings 60 are pressed against the reference portion 51 and formation of gaps between the plurality of uneven rings 60 is suppressed.

Note that instead of such a configuration, the restriction portion 53 may be provided to be fixed. In such a case, the compression spring 54 and the stopper 55 can be omitted.

In addition, regarding the uneven roller 45A shown in FIGS. 4 to 10, the protrusion portions 61A of one uneven ring 60A and the protrusion portions 61A of the uneven ring 60A that is adjacent to the one uneven ring 60A are disposed at different positions in the circumferential direction and partially overlap with each other in the axial direction. In other words, the protrusion portions 61A are disposed to alternate along the axial direction. Accordingly, it is possible to suppress formation of a noticeable line at the medium P along the axial direction, that is, a medium width direction.

Note that the medium transportation device 40 may further include a heating unit that heats the shaft portion 49 constituting the uneven roller 45. FIG. 37 shows a cross section of a shaft portion 49D which is an example of the shaft portion 49 to be heated. The shaft portion 49D is formed in a hollow shape, a heater 112, which is an example of the heating unit, is provided inside the shaft portion 49D, and the shaft portion 49D is heated by the heater 112. According to such a configuration, the drying of the medium P can be performed in addition to curl correction of the medium P that is performed by the uneven roller 45.

Claw Portion Separating Medium from Uneven Roller

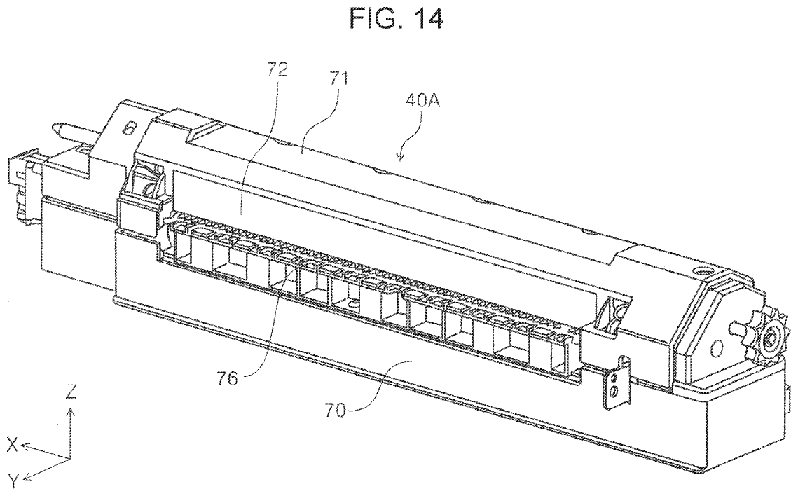

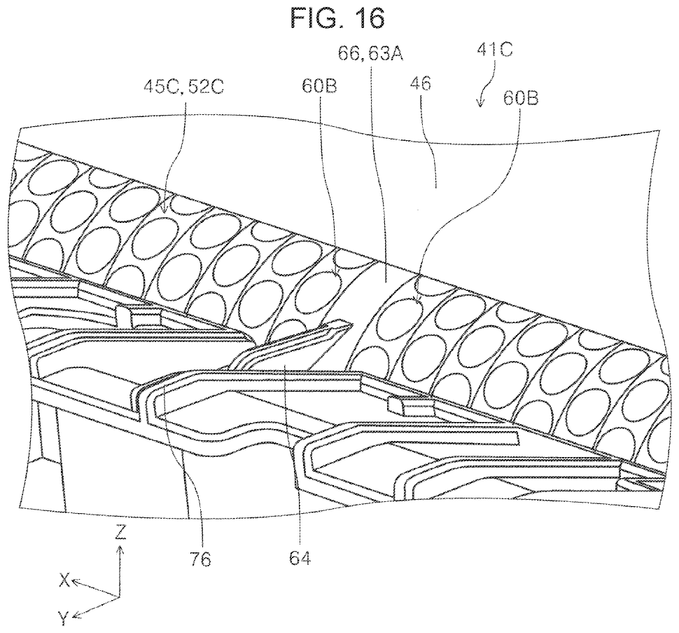

Next, claw portions 64 that separate the medium P from the uneven roller 45 will be described with reference to FIGS. 14 to 25. The medium transportation device 40 may include the claw portions 64 which will be described later.

FIG. 14 is a perspective view of a medium transportation device 40A. The medium transportation device 40A includes a main body 70 and a cover 71 provided at an upper portion of the main body 70.

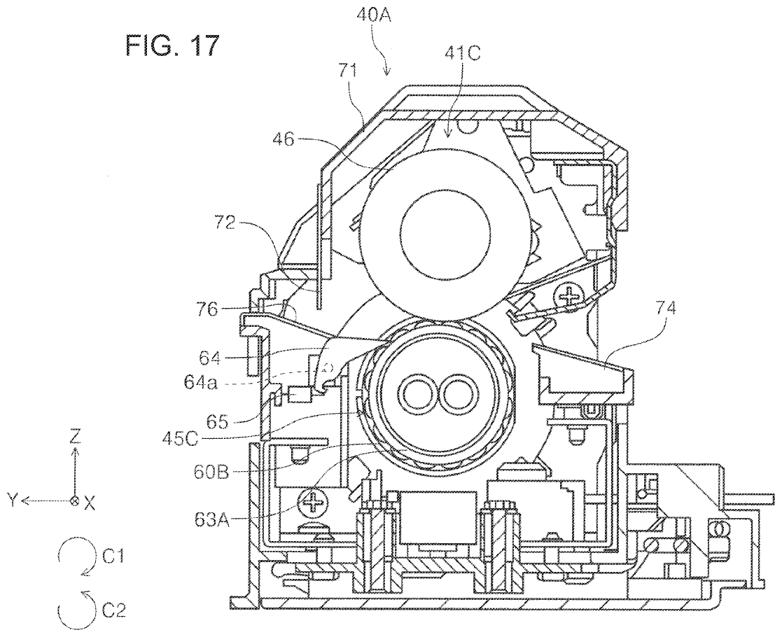

As shown in FIG. 17, a transportation roller pair 41C of the medium transportation device 40A includes an uneven roller 45C and the elastic roller 46 which is an example of a facing roller. Therefore, the configuration for the medium transportation device 40A to correct a curl of the medium P is equivalent to the configuration described with reference to FIG. 2.

An upstream guide 74 is provided upstream of the transportation roller pair 41C, and the medium P is guided to the transportation roller pair 41C by the upstream guide 74. The medium P nipped by the transportation roller pair 41C is guided downstream by a downstream guide 76.

A wall portion 72 is provided above the downstream guide 76 to be hung from the cover 71 and thus leakage of an abnormal sound generated in the transportation roller pair 41C to the outside of the device can be suppressed. Therefore, it is preferable that the wall portion 72 is made of a material having favorable sound absorption properties.

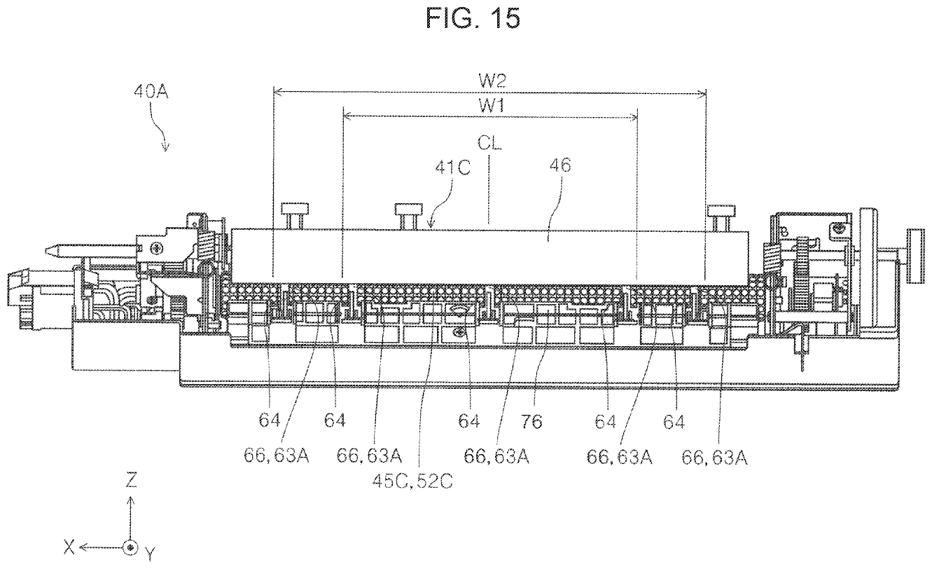

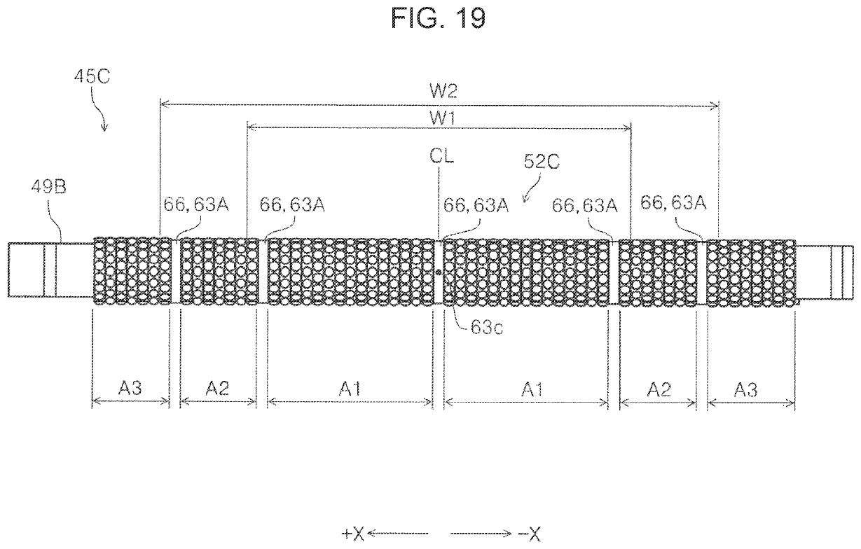

As shown in FIGS. 15, 16, and 19, the uneven roller 45C constituting the transportation roller pair 41C includes a ring portion 52C. Note that in FIG. 19, the reference portion 51 and the restriction portion 53 are not shown.

Regarding the ring portion 52C according to the present embodiment, non-uneven regions 66, in which the protrusion portions 61 are not provided along the circumferential direction and protrusions and recesses and are not formed, are formed at portions of the ring portion 52C in the axial direction. In the present embodiment, the non-uneven regions 66 are formed by outer peripheral surfaces of facing rings 63.

In the present embodiment, the facing ring 63 is formed of resin. For example, the facing ring 63 is formed of polyoxymethylene (POM). The facing ring 63 has an inner diameter slightly larger than the outer diameter of a shaft portion 49B and is formed to be slidable along the axial direction and not to wobble in the radial direction when being slid onto the shaft portion 49B.

In addition, as shown in FIGS. 15, 16, and 17, the medium transportation device 40A includes the claw portions 64 provided at positions facing the facing rings 63 forming the non-uneven regions 66.

The claw portions 64 are provided downstream of the uneven roller 45C in a medium transportation direction. The claw portions 64 are provided to be rotatable around rotary shafts 64a with respect to the downstream guide 76 and are pressed in the rotation direction C1 by tension springs 65, which are examples of a pressing member. Accordingly, tip ends of the claw portions 64, that is, upstream ends of the claw portions 64 that come into contact with the facing rings 63 are pressed against the facing rings 63.

In FIGS. 15 and 19, a reference numeral “CL” indicates a central position of the ring portion 52C in the medium width direction. A central position of the medium P in the medium width direction coincides with a central position CL regardless of the size of the medium P. As shown in FIGS. 15 and 19, in the present embodiment, the facing rings 63 and the claw portions 64 are provided at the central position CL and positions that are symmetrical with respect to the central position CL in the medium width direction.

A reference numeral “W1” indicates a region in which a first medium P1 comes into contact with the uneven roller 45C and a reference numeral “W2” indicates a region in which a second medium P2, which has a size larger than that of the first medium P1, comes into contact with the uneven roller 45C. Facing rings 63A and the claw portions 64 are disposed slightly closer to an inner side than side ends of the first medium P1 are and are disposed slightly closer to the inner side than side ends of the second medium P2 are.

In this way, a plurality of the facing rings 63A and the claw portions 64 are provided at intervals in the axial direction, that is, the medium width direction. However, the number of the facing rings 63A provided in the medium width direction and the number of the claw portions 64 provided in the medium width direction may be one.

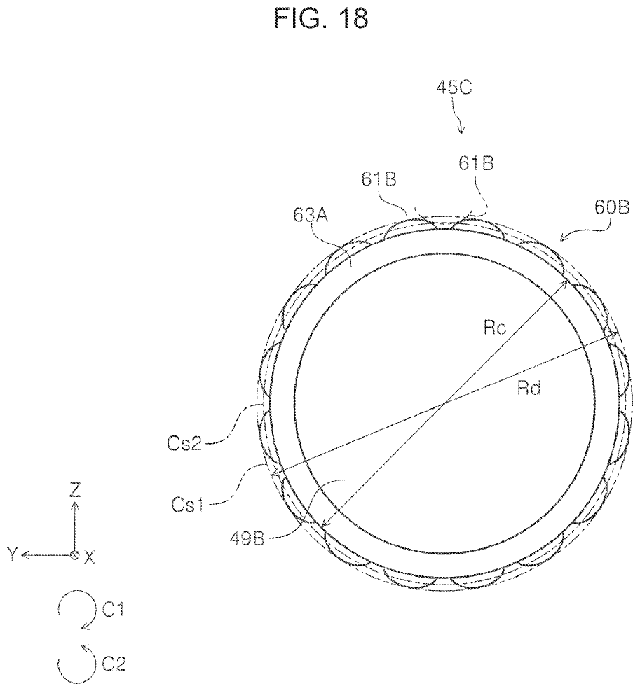

In FIG. 18, a reference numeral “Rd” indicates the outermost diameter of the uneven ring 60B and a reference numeral “Rc” indicates the outermost diameter of the facing ring 63A. As shown in the drawing, an outermost diameter Rc of the facing ring 63A is smaller than an outermost diameter Rd of the uneven ring 60B.

Note that in FIG. 18, a reference numeral “Cs1” is an outermost diameter circle corresponding to the outermost diameter Rd of the uneven ring 60B. In addition, a reference numeral “Cs2” indicates a circle that links points of contact where the protrusion portions 61B of two facing uneven rollers 45C come into contact with each other when a roller facing the uneven roller 45C is the uneven roller 45C also. Hereinafter, such a circle will be referred to as a “contact circle Cs2”. The contact circle Cs2 is a circle similar to the pitch circle of a gear.

As illustrated in the drawing, the outermost diameter Rc of the facing ring 63A is even smaller than the diameter of the contact circle Cs2.

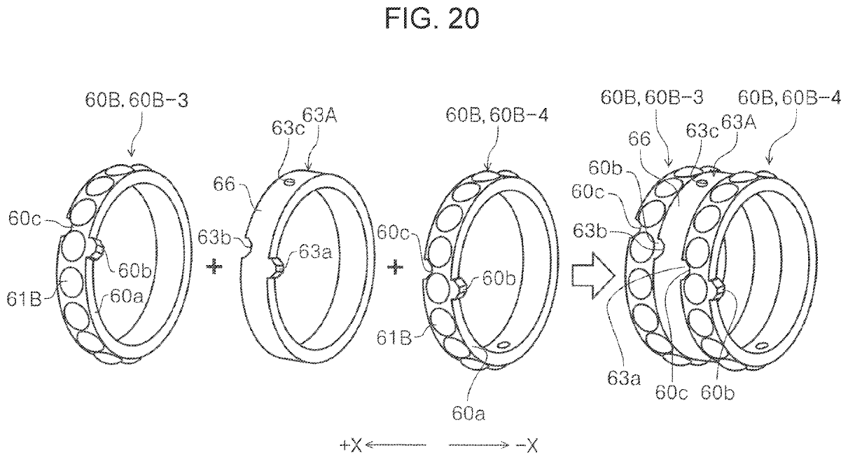

FIG. 20 is a view showing engagement between the facing ring 63A and two uneven rings 60B sandwiching the facing ring 63A and shows a portion of an assembly step. Note that the uneven ring 60B that is positioned closer to the side, to which the +X direction extends, than the facing ring 63A is will be referred to as a first uneven ring 60B-3 and the uneven ring 60B that is positioned closer to the side, to which the −X direction extends, than the facing ring 63A is will be referred to as a second uneven ring 60B-4.

The facing ring 63A includes a first engaged portion 63b that can engage with the reference portion side engaging portion 60b of the first uneven ring 60B-3. Since the reference portion side engaging portion 60b has a protruding shape, the first engaged portion 63b is formed in a recessed shape that accommodates the protruding shape. The reference portion side engaging portion 60b is an example of a first engaging portion that can engage with the first engaged portion 63b.

In addition, the facing ring 63A includes a second engaged portion 63a that can engage with the restriction portion side engaging portion 60c of the second uneven ring 60B-4. Since the restriction portion side engaging portion 60c has a recessed shape, the second engaged portion 63a is formed in a protruding shape that is fit to the recessed shape. The restriction portion side engaging portion 60c is an example of a second engaging portion that can engage with the second engaged portion 63a.

At the time of assembly of the uneven roller 45C, after the second uneven ring 60B-4 is slid onto the shaft portion 49B, the facing ring 63A is slid onto the shaft portion 49B and then the first uneven ring 60B-3 is slid onto the shaft portion 49B. Accordingly, as shown on the rightmost side in FIG. 20, the first uneven ring 60B-3, the second uneven ring 60B-4, and the facing ring 63A enter a state of being combined with each other.

Note that regarding the uneven roller 45C, the protrusion portions 61B of the two uneven rings 60B-3 and 60B-4 sandwiching the facing ring 63A are disposed at the same positions in the circumferential direction.

In the present embodiment, a dimension of the facing ring 63A in a width direction is substantially equal to a dimension of the uneven ring 60B in the width direction.

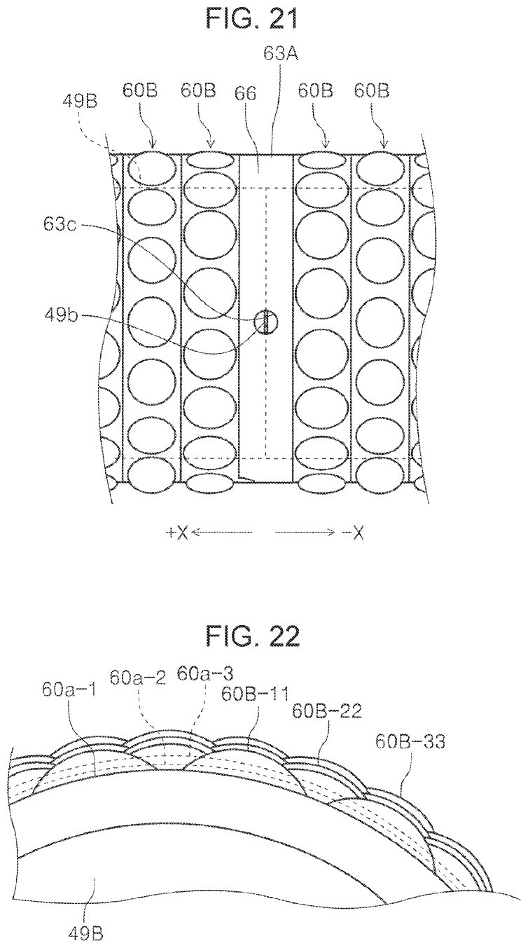

As shown in FIG. 21, a hole 63c is formed at a portion of an outer peripheral surface of the facing ring 63A in the circumferential direction. In addition, at the shaft portion 49B, a scribe line 49b, which is an example of a mark, is formed along the circumferential direction. At a position where the facing ring 63A is planned to be disposed, the scribe line 49b is formed in advance in a step of manufacturing the shaft portion 49B. Accordingly, when the facing ring 63A is slid onto the shaft portion 49B, the scribe line 49b in the hole 63c can be visually recognized as shown in FIG. 21 in a case where the facing ring 63A is disposed at a correct position in the axial direction. That is, it is possible to check whether or not the facing ring 63A is disposed at the correct position.

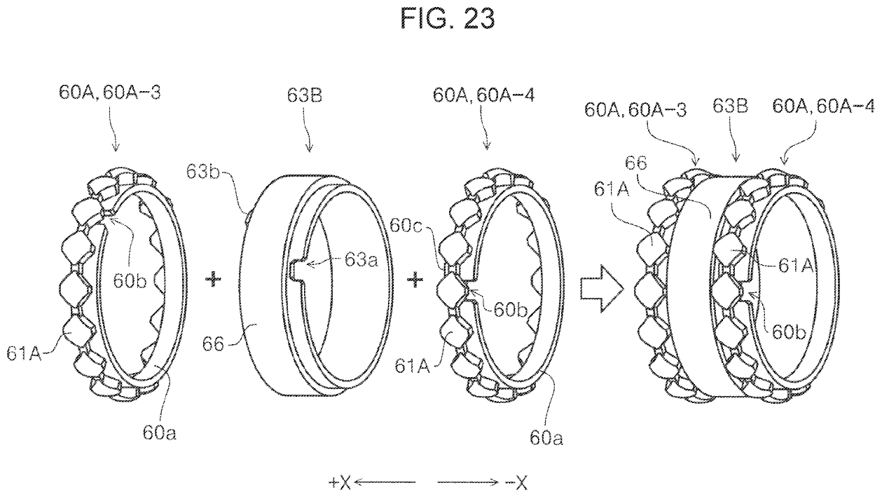

FIG. 23 shows a facing ring 63B according to another embodiment, and the facing ring 63B is applied to the uneven ring 60A described with reference to FIGS. 4 to 10.

The uneven ring 60A that is positioned closer to the side, to which the +X direction extends, than the facing ring 63B is will be referred to as a first uneven ring 60A-3 and the uneven ring 60A that is positioned closer to the side, to which the −X direction extends, than the facing ring 63B is will be referred to as a second uneven ring 60A-4.

The facing ring 63B includes the first engaged portion 63b that can engage with the reference portion side engaging portion 60b of the first uneven ring 60A-3. Since the reference portion side engaging portion 60b has a recessed shape, the first engaged portion 63b is formed in a protruding shape that is fit to the recessed shape. The reference portion side engaging portion 60b is an example of a first engaging portion that can engage with the first engaged portion 63b.

In addition, the facing ring 63B includes the second engaged portion 63a that can engage with the restriction portion side engaging portion 60c of the second uneven ring 60A-4. Since the restriction portion side engaging portion 60c has a protruding shape, the second engaged portion 63a is formed in a recessed shape that accommodates the protruding shape. The restriction portion side engaging portion 60c is an example of a second engaging portion that can engage with the second engaged portion 63a.

In the assembly step, after the second uneven ring 60A-4 is slid onto the shaft portion 49B, the facing ring 63B is slid onto the shaft portion 49B and then the first uneven ring 60A-3 is slid onto the shaft portion 49B. Accordingly, as shown on the rightmost side in FIG. 23, the first uneven ring 60A-3, the second uneven ring 60A-4, and the facing ring 63B enter a state of being combined with each other.

Note that in the present embodiment as well, the protrusion portions 61A of the two uneven rings 60A sandwiching the facing ring 63B are disposed at the same positions in the circumferential direction.

In the present embodiment, a dimension of the facing ring 63B in the width direction is larger than that of the uneven ring 60A and is larger than that of the facing ring 63A described with reference to FIG. 21. For example, in the present embodiment, the dimension of the facing ring 63B in the width direction is two times the dimension of the facing ring 63A, which is described with reference to FIG. 21, in the width direction.

As described above, the medium transportation device 40 includes the uneven roller 45 of which a surface coming into contact with the medium P is provided with a plurality of protrusions and recesses, the elastic roller 46 that nips the medium P together with the uneven roller 45, and the claw portions 64 that guide the medium P to be separated from the uneven roller 45. Accordingly, it is possible to facilitate peeling the medium P off from the uneven roller 45.

In addition, the non-uneven regions 66 in which protrusions and recesses are not formed along the circumferential direction are formed at a portion of the uneven roller 45 in the axial direction and the claw portions 64 face the non-uneven regions 66. Therefore, wear on or damage to the claw portions 64 and the protrusions and recesses, which is caused when the claw portions 64 come into contact with protrusions and recesses, can be suppressed.

Note that the claw portions 64 may abut outer peripheral surfaces of the non-uneven regions 66 or may be separated from the outer peripheral surfaces of the non-uneven regions 66.

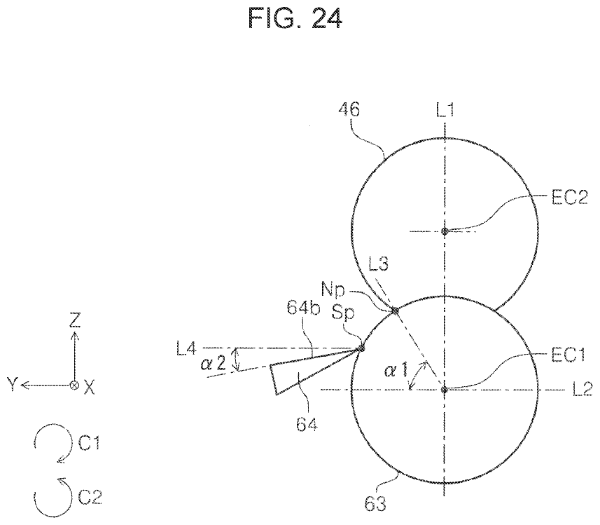

Note that when the claw portion 64 abuts the facing ring 63, as shown in FIG. 24, it is preferable that a contact position Sp therebetween is provided within the interior of an angle α1 in the rotation direction C2 from a downstream position Np of a nip region between the facing ring 63 and the elastic roller 46. An example of the angle α1 is 90°. Another example of the angle α1 is 45°.

Here, in FIG. 24, a point EC1 indicates the central position of the facing ring 63, a point EC2 indicates the central position of the elastic roller 46, and a straight line L1 is a straight line passing through the point EC1 and the point EC2. In addition, a straight line L2 is a straight line passing through the central position EC1 and is a straight line orthogonal to the straight line L1, and a straight line L3 is a straight line passing through the downstream position Np of the nip region and the central position EC1. The angle α1 is an angle formed by the straight line L3 and the straight line L2. When the contact position Sp is disposed as described above, the medium P can be appropriately peeled off from the uneven roller 45.

In addition, a straight line L4 is a straight line passing through the contact position Sp and is a straight line orthogonal to the straight line L1. It is preferable that an angle α2 formed by an upper surface 64b of the claw portion 64 and the straight line L4 at the contact position Sp falls within a range of 0° to 20°. Accordingly, the medium P can be appropriately peeled off from the uneven roller 45.

In addition, in the present embodiment, the outermost diameter Rc of the facing ring 63 is smaller than the outermost diameter Rd of the uneven ring 60. Accordingly, the tip end of the claw portion 64 can enter a space inside an outermost diameter circle Cs1 of the uneven ring 60 and it is possible to more reliably peel the medium P off from the uneven roller 45 with the claw portion 64.

In addition, in the present embodiment as well, the first engaging portion (that is, the reference portion side engaging portion 60b) and the second engaging portion (that is, the restriction portion side engaging portion 60c) can engage with each other as described above and thus the uneven rings 60 that are adjacent to each other can engage with each other. Therefore, it is not necessary to provide a configuration for the positioning of the uneven rings 60 that are adjacent to each other and thus the configuration can be simplified.

Note that, an engaging portion for the positioning of the uneven rings 60 that are adjacent to each other does not need to also serve as an engaging portion for the positioning of the uneven ring 60 adjacent to the facing ring 63 and the facing ring 63 and the engaging portions may be configured separately from each other. In such a case, the engaging portion for the positioning of the uneven ring 60 adjacent to the facing ring 63 and the facing ring 63 may be provided for only the uneven ring 60 adjacent to the facing ring 63 or may be provided for every uneven ring 60.

In addition, in the present embodiment as well, in a state where two uneven rings 60 adjacent to each other engage with each other, the protrusion portions 61 of one uneven ring 60 and the protrusion portions 61 of another uneven ring 60 are disposed at different positions in the circumferential direction. Accordingly, it is possible to suppress formation of a noticeable line at the medium P along the axial direction, that is, a medium width direction.

In addition, in the present embodiment, the facing ring 63 and the claw portion 64 are disposed at the central position CL, which is the center of the ring portion 52 in the medium width direction. Accordingly, right and left sides of the medium P can be evenly peeled off with respect to the central position CL in the medium width direction and thus the medium P can be restrained from being skewed after being peeled off.

In addition, in the present embodiment, the facing ring 63 and the claw portion 64 are provided at symmetrical positions with respect to the central position CL of the ring portion 52 in the medium width direction and are provided inside end portions, in the width direction, of the medium P having a predetermined size. Accordingly, right and left sides of the medium P can be evenly peeled off with respect to the central position CL in the medium width direction and thus the medium P can be restrained from being skewed after being peeled off.

In addition, the scribe line 49b, which is an example of a mark, is formed at a region where the facing ring 63 is mounted, that is, a portion of an outer peripheral surface of the shaft portion 49 onto which the facing ring 63 is mounted. In addition, at least a portion of the facing ring 63 that faces the scribe line 49b is configured such that the mark can be visually recognized and the hole 63c is formed at the facing ring 63 in the present embodiment. Accordingly, as described above, it is easy to recognize a position onto which the facing ring 63 is to be mounted when the uneven roller 45 is assembled. In addition, since the facing ring 63 is configured such that the mark can be visually recognized, it is possible to easily check whether or not the facing ring 63 is mounted onto a correct position after the uneven roller 45 is assembled.

Note that as a configuration in which the scribe line 49b is made visually recognizable, a configuration in which the facing ring 63 is made partially transparent instead of being provided with the hole 63c may also be adopted.

Note that a configuration in which the outermost diameter Rd of the uneven roller 45 increases from a region where the plurality of protrusions and recesses are formed (that is, the central position CL of the ring portion 52 in the axial direction) toward axial ends may also be adopted.

For example, when regions each of which is between two facing rings 63A in FIG. 19 are referred to as regions A1, A2, and A3 in order from the central position CL to the axial ends, a configuration in which the outermost diameters Rd at the regions increase in this order may also be adopted.

In FIG. 22, an uneven ring 60B-11 is an uneven ring constituting the region A1. Similarly, an uneven ring 60B-22 is an uneven ring constituting the region A2, and an uneven ring 60B-33 is an uneven ring constituting the region A3.

As an example, the outermost diameter Rd of the uneven ring 60B-11 can be set to 30.5 mm, the outermost diameter Rd of the uneven ring 60B-22 can be set to 31.0 mm, and the outermost diameter Rd of the uneven ring 60B-33 can be set to 31.5 mm.

Note that in such a case, the outer diameters of the base portions 60a of the uneven rings can also be caused to increase toward the axial end. For example, the outer diameter of a base portion 60a-1 of the uneven ring 60B-11 can be set to 28.5 mm, the outer diameter of a base portion 60a-2 of the uneven ring 60B-22 can be set to 29.0 mm, and the outer diameter of a base portion 60a-3 of the uneven ring 60B-33 can be set to 29.5 mm.

Note that for example, the protrusion portion 61B can be formed in the form of a portion of a sphere having a diameter of 3.0 mm.

In addition, the outer diameter of the elastic roller 46 can be set to 35.0 mm, for example.

According to a configuration in which the outermost diameter Rd of the uneven roller 45 increases from the central position CL toward the axial ends as described above, the speed of medium transportation is increased at a position on axial end sides in comparison with the central position CL. Accordingly, the medium P is pulled in directions toward the axial ends and thus formation of wrinkles at the medium P can be suppressed.

Note that the outermost diameter Rd of the uneven roller 45 does not need to stepwisely increase toward the axial ends as in the above-described embodiment and may continuously increase toward the axial ends.

According to a configuration in which the outermost diameter Rd of the uneven roller 45 changes with the facing ring 63 as a boundary as in the present embodiment, the uneven rings 60 that are the same as each other can be used between two facing rings 63. Therefore, it is possible to suppress an increase in cost of the uneven rings 60, and the assembly step is facilitated. That is, the uneven rings 60 that are the same as each other can be used in each of the regions A1, A2, and A3. Therefore, it is possible to suppress an increase in cost of the uneven rings 60, and the assembly step is facilitated.

Note that in the configuration in which the outermost diameter Rd of the uneven roller 45 increases toward the axial ends, the outermost diameters Rc of a plurality of the facing rings 63 may be different from each other or may be equal to each other. When the outermost diameters Rc of the plurality of facing rings 63 are equal to each other, the same components can be used for the plurality of facing rings 63 and an increase in cost of the component can be suppressed.

For example, when the outer diameter of the base portion 60a of the uneven ring 60B-1 is set to 28.5 mm, the outermost diameter Rc of the facing ring 63 can also be set to 28.5 mm.

Note that in the configuration in which the outermost diameter Rd of the uneven roller 45 increases toward the axial ends, the outer diameters of the base portions 60a may be different from each other as described above or may be equal to each other. When the outer diameters of the base portions 60a are different from each other, a difference between the outermost diameters Rd of the uneven rings 60 is made by a difference between the amounts of protrusion of the protrusion portions 61 from the base portions 60a. Accordingly, the following action and effect can be achieved.

Even when the outermost diameters Rd of the uneven rings 60 are different from each other, it is difficult to determine, from the external appearances thereof, that the outermost diameters Rd of the uneven rings 60 are different from each other when there is no difference between the amounts of protrusion of the protrusion portions 61 from the base portions 60a. However, since a difference between the outermost diameters Rd of the uneven rings 60 is made by a difference between the amounts of protrusion of the protrusion portions 61 from the base portions 60a, it is easy to determine, from the external appearances thereof, that the outermost diameters Rd of the uneven rings 60 are different from each other. Accordingly, manufacturing the uneven roller 45 is facilitated.

Note that the medium transportation device 40 may further include a heating unit that heats the shaft portion 49 constituting the uneven roller 45. FIG. 37 shows a cross section of the shaft portion 49D which is an example of the shaft portion 49 to be heated. The shaft portion 49D is formed in a hollow shape, a heater 112, which is an example of the heating unit, is provided inside the shaft portion 49D, and the shaft portion 49D is heated by the heater 112. According to such a configuration, the drying of the medium P can be performed in addition to curl correction of the medium P that is performed by the uneven roller 45.

In addition, in the above-described embodiment, only one of facing rollers of the transportation roller pair 41C is configured as the uneven roller 45. However, both of the facing rollers may be configured as the uneven rollers 45.

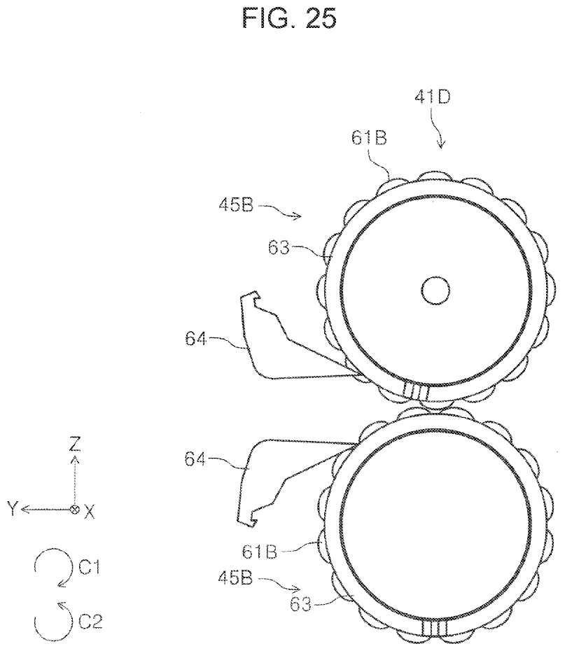

FIG. 25 shows an example of such a configuration and both of facing rollers of the transportation roller pair 41D are configured as the uneven rollers 45B. In such a case, the protrusion portion 61B of one uneven roller 45B enters a space between two protrusion portions 61B of another uneven roller 45B.

In such a configuration, it is preferable that the claw portions 64 are provided for each of the two uneven rollers 45B. Accordingly, even when the medium P adheres to one of the two uneven rollers 45B, the medium P can be appropriately peeled off.

Note that the claw portions 64 may be omitted from the above-described medium transportation device 40 and a medium transportation device may be configured to include the uneven roller 45 provided with the non-uneven regions 66.

Configuration in which Plurality of Transportation Roller Pairs are Provided

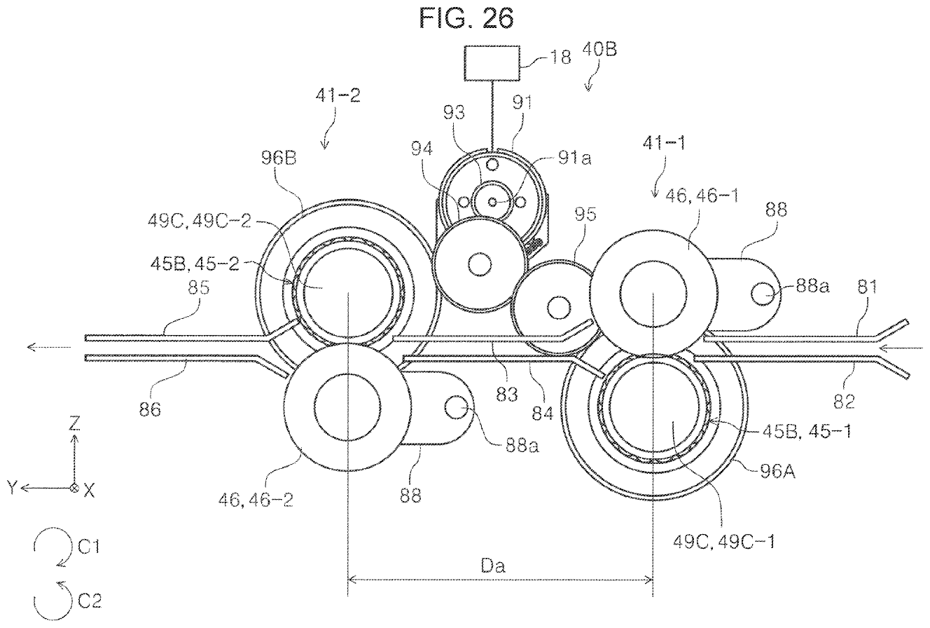

Next, the medium transportation device 40 including a plurality of the transportation roller pairs 41 will be described with reference to FIGS. 26 to 31.

A medium transportation device 40B shown in FIG. 26 includes a first transportation roller pair 41-1 and a second transportation roller pair 41-2 that is positioned downstream of the first transportation roller pair 41-1 in the medium transportation direction.

The medium P is guided to the first transportation roller pair 41-1 by a first upper guide 81 and a first lower guide 82. In addition, the medium P is guided to the second transportation roller pair 41-2 by a second upper guide 83 and a second lower guide 84. In addition, the medium P is guided downstream from the second transportation roller pair 41-2 by a third upper guide 85 and a third lower guide 86.

The first transportation roller pair 41-1 nips and transports the medium P by means of a first uneven roller 45-1 and a first elastic roller 46-1 which is a first facing roller facing the first uneven roller 45-1. The first uneven roller 45-1 is rotationally driven in the rotation direction C2 by a motor 91 and the first elastic roller 46-1 is driven to rotate in the rotation direction C1.

The second transportation roller pair 41-2 nips and transports the medium P by means of a second uneven roller 45-2 and a second elastic roller 46-2, which is a second facing roller facing the second uneven roller 45-2. The second uneven roller 45-2 is rotationally driven in the rotation direction C1 by the motor 91 and the second elastic roller 46-2 is driven to rotate in the rotation direction C2.

Note that as the first uneven roller 45-1 and the second uneven roller 45-2 according to the present embodiment, for example, the uneven rollers 45B are adopted and the uneven rings 60B described with reference to FIG. 11 are adopted. However, the present disclosure is not limited thereto. The uneven rings 60A described with reference to FIGS. 4 to 10 or other types of uneven rings 60 may also be adopted and the above-described facing ring 63 may be included between the plurality of uneven rings 60. That is, the first uneven roller 45-1 and the second uneven roller 45-2 may be any types of uneven rollers 45.

The motor 91 controlled by the control unit 18 includes a motor gear 93 provided at a motor shaft 91a, and a gear 94 meshes with the motor gear 93.

A roller gear 96B is provided at an axial end of the second uneven roller 45-2 and the roller gear 96B meshes with the gear 94 so that power is transmitted from the motor 91 to the second uneven roller 45-2.

In addition, a gear 95 meshes with the gear 94. A roller gear 96A is provided at an axial end of the first uneven roller 45-1 and the roller gear 96A meshes with the gear 95 so that power is transmitted from the motor 91 to the first uneven roller 45-1.

For transmission of power from the motor 91 to each roller, a drive belt or the like may also be used instead of the gears, for example.

The elastic roller 46 is used as each of the first elastic roller 46-1 and the second elastic roller 46-2 and each elastic roller is pivotally supported by a roller supporting member 88 that is rotatable around a shaft 88a. The roller supporting member 88 that supports the first elastic roller 46-1 is pressed in the rotation direction C2 by a spring force of a pressing member (not shown) such as a spring and thus the first elastic roller 46-1 is pressed against the first uneven roller 45-1.

In addition, the roller supporting member 88 that supports the second elastic roller 46-2 is pressed in the rotation direction C1 by a spring force of a pressing member (not shown) such as a spring and thus the second elastic roller 46-2 is pressed against the second uneven roller 45-2.

In the medium transportation device 40B, the first uneven roller 45-1 comes into contact with the first surface S1 of the medium P and the second uneven roller 45-2 comes into contact with the second surface S2 of the medium P and it is a matter of course that the first uneven roller 45-1 may come into contact with the second surface S2 of the medium P and the second uneven roller 45-2 may come into contact with the first surface S1 of the medium P.

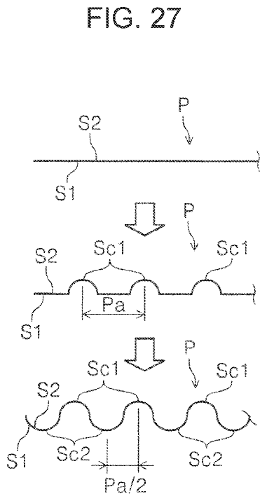

FIG. 27 shows the order in which protrusions and recesses that are formed at the medium P by the uneven roller 45B are formed and as indicated by a change from an uppermost view to a central view in FIG. 27, protrusion portions Sc1 that protrude upward are formed at the second surface S2 of the medium P by the first uneven roller 45-1. However, the protrusion portions Sc1 are shapes formed in a state where the first uneven roller 45-1 is in contact with the medium P and the protrusion portions Sc1 may not remain at the medium P after the medium P passes through the first uneven roller 45-1.

As indicated by a change from the central view to a lowermost view in FIG. 27, protrusion portions Sc2 that protrude downward are formed at the first surface S1 of the medium P by the second uneven roller 45-2. However, the protrusion portions Sc2 are shapes formed in a state where the second uneven roller 45-2 is in contact with the medium P and the protrusion portions Sc2 may not remain at the medium P after the medium P passes through the second uneven roller 45-2.

Note that a reference numeral “pa” indicates a formation interval between the protrusion portions Sc1 in the medium transportation direction and a formation interval between the protrusion portions Sc2 and the formation intervals correspond to a pitch interval between two protrusion portions 61 that are adjacent to each other in the circumferential direction. Hereinafter, the formation interval will be referred to as a pitch interval pa.

In the present embodiment, a formation interval between the protrusion portion Sc1 and the protrusion portion Sc2 in the medium transportation direction is pa/2, that is, the protrusion portion Sc2 is formed between two protrusion portions Sc1 in the medium transportation direction. However, the present disclosure is not limited thereto as long as positions at which the protrusion portions Sc1 are formed and positions at which the protrusion portions Sc2 are formed are offset from each other in the medium transportation direction instead of completely coinciding with each other in the medium transportation direction.

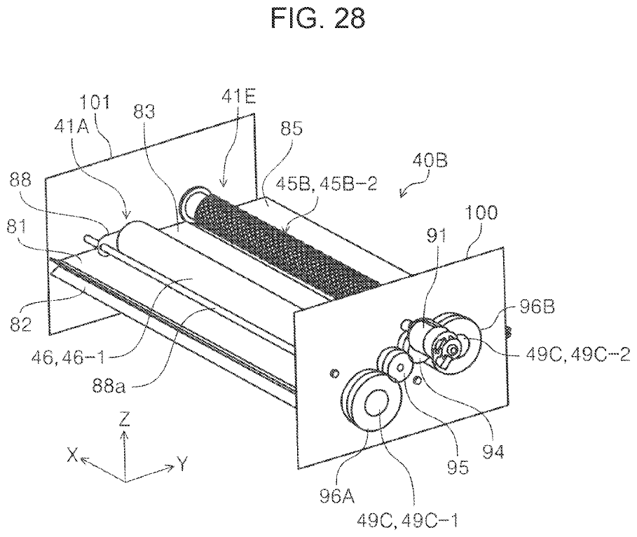

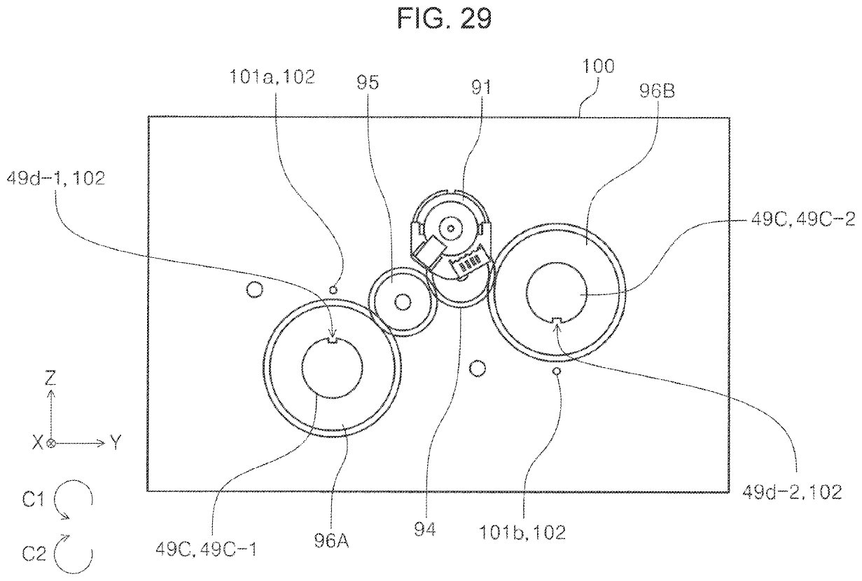

Next, as shown in FIGS. 28 and 29, the medium transportation device 40B includes frames 100 and 101 that support the first uneven roller 45-1 and the second uneven roller 45-2. The frames 100 and 101 are disposed at an interval in the medium width direction and rotatably support a shaft portion 49C-1 of the first uneven roller 45-1 and a shaft portion 49C-2 of the second uneven roller 45-2. In addition, the frames 100 and 101 rotatably support the shafts 88a. In addition, the motor 91 is attached to the frame 100 and the gears 94 and 95 are rotatably supported by the frame 100.

The medium transportation device 40B includes a phase defining unit 102 that defines the phase of rotation of the first uneven roller 45-1 and the phase of rotation of the second uneven roller 45-2. The phase defining unit 102 according to the present embodiment is composed of phase alignment signs provided at the first uneven roller 45-1, the second uneven roller 45-2, and the frame 100 as shown in FIG. 29.

A reference numeral “49d-1” indicates a phase alignment sign provided at the shaft portion 49C-1 of the first uneven roller 45-1, and a reference numeral “49d-2” indicates a phase alignment sign provided at the shaft portion 49C-2 of the second uneven roller 45-2. In the present embodiment, phase alignment signs 49d-1 and 49d-2 are formed by partially cutting out outer peripheral portions of axial ends of the shaft portions 49C. However, the present disclosure is not limited thereto and marks formed by projections provided at axial end surfaces, engravement, coloring, or the like may also be adopted.

In addition, reference numerals “101a” and “101b” indicate phase alignment signs provided at the frame 100. In the present embodiment, phase alignment signs 101a and 101b are formed by projections provided at a frame surface of the frame 100. However, the present disclosure is not limited thereto marks formed by recess portions provided at the frame surface, notches, coloring, or the like may also be adopted.

The phase alignment signs 49d-1 and 49d-2 provided at the shaft portions 49C indicate the positions of the protrusion portions 61B in the present embodiment. Although the reference portion 51 in the present embodiment is not shown in details in the drawing, the reference portion 51 has a configuration obtained when a gear is integrally formed with the reference portion 51B described with reference to FIG. 11. In addition, when the reference portions 51B are fixed to the shaft portions 49C, the protrusion portions 61B of the uneven rings 60B adjacent to the reference portions 51B coincide with the phase alignment signs 49d-1 and 49d-2 provided at the shaft portions 49C.

In addition, as shown in FIG. 29, the gears are caused to mesh with each other such that the phase alignment sign 49d-1 of the first uneven roller 45-1 and the phase alignment sign 101a of the frame 100 coincide with each other and the phase alignment sign 49d-2 of the second uneven roller 45-2 and the phase alignment sign 101b of the frame 100 coincide with each other. Accordingly, a state where the protrusion portion 61B of the first uneven roller 45-1 abuts the medium P straight and the protrusion portion 61B of the second uneven roller 45-2 abuts the medium P straight can be achieved.

When a shaft-to-shaft distance Da (refer to FIG. 26) or the like which will be described later is adjusted with the above-described state being used as a basic state, positions at which the protrusion portions Sc1 are formed and positions at which the protrusion portions Sc2 are formed can be made offset from each other in the medium transportation direction as shown in FIG. 27.

Note that when any of the phase alignment signs do not coincide with each other, it is possible to cause the phase alignment signs to coincide with each other, since it is possible to rotate the first uneven roller 45-1 and the second uneven roller 45-2 when removing the gear 95.

Here, a method of making the protrusion portions Sc1 formed at the second surface S2 of the medium P and the protrusion portions Sc2 formed at the first surface S1 offset from each other as shown in FIG. 27 will be described.

In FIG. 26, the distance Da is a shaft-to-shaft distance of the first uneven roller 45-1 and the second uneven roller 45-2.

In addition, the pitch interval pa can be obtained from the following equation (1), where pa is the pitch interval between two protrusion portions 61B of the uneven ring 60B that are adjacent to each other in the circumferential direction, θa (refer to FIG. 2) is a pitch angle, and Rd (refer to FIG. 18) is the outermost diameter of the uneven ring 60B.

$$pa = Rd \times π \times θa / 2 π \qquad ( 1 )$$

In addition, the shaft-to-shaft distance Da can be set as in the following equation (2), for example.

$$Da = pa \times n + pa / 2 ( n is a positive integer ) \qquad ( 2 )$$

By setting at least one of the shaft-to-shaft distance Da and the pitch interval pa to satisfy the above-described equations, it is possible to make the protrusion portions Sc1 formed at the second surface S2 of the medium P and the protrusion portions Sc2 formed at the first surface S1 offset from each other as shown in FIG. 27.

Note that this is on an assumption that phase alignment as described with reference to FIG. 29 is performed and the protrusion portion 61B of the first uneven roller 45-1 is in a state of abutting the medium P straight and the protrusion portion 61B of the second uneven roller 45-2 is in a state of abutting the medium P straight. Therefore, by making the positions of the protrusion portions 61B of the respective rollers after phase alignment offset from each other, it is possible to make the protrusion portions Sc1 formed at the second surface S2 of the medium P and the protrusion portions Sc2 formed at the first surface S1 offset from each other in the medium transportation direction.

It is possible to adjust the positions of the protrusion portions 61B of the respective rollers after the phase alignment by making the positions of the protrusion portions 61B offset from the phase alignment signs or making the positions offset from the reference portions 51 in a rotation direction of the uneven rings 60B. For example, it is also preferable to configure the reference portion 51 to be dedicated for each of the first uneven roller 45-1 and the second uneven roller 45-2.

In the medium transportation device 40B described above, the first uneven roller 45-1 and the second uneven roller 45-2 are driven by one motor 91. However, each of the first uneven roller 45-1 and the second uneven roller 45-2 may be driven by a motor dedicated thereto.

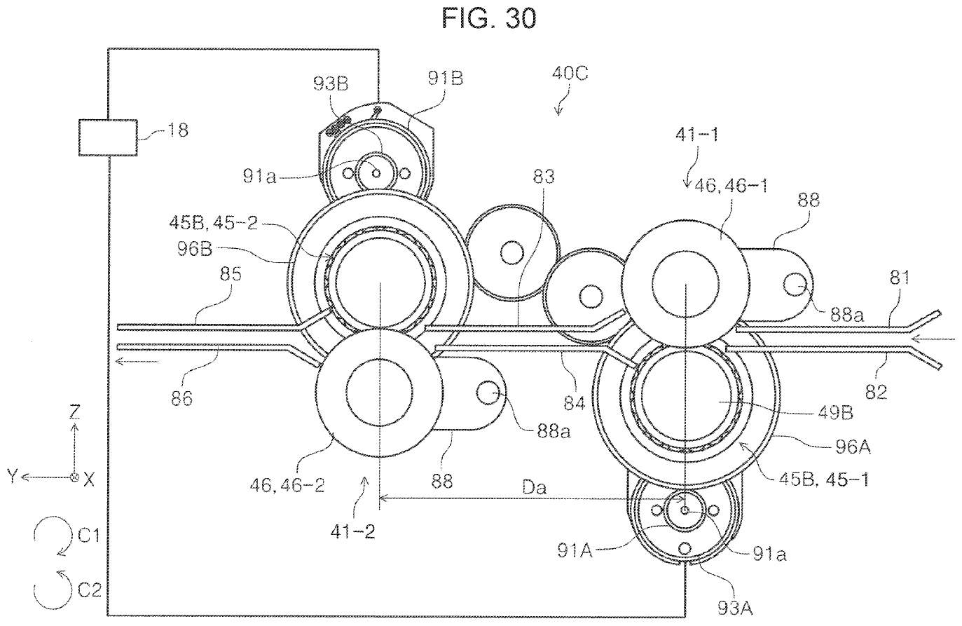

FIG. 30 shows a medium transportation device 40C having such a configuration, and the medium transportation device 40C includes motors 91A and 91B.

A motor gear 93A is provided at the motor shaft 91a of the motor 91A and the motor gear 93A meshes with the roller gear 96A, so that the first uneven roller 45-1 is driven by the motor 91A.

A motor gear 93B is provided at the motor shaft 91b of the motor 91B and the motor gear 93B meshes with the roller gear 96B, so that the second uneven roller 45-2 is driven by the motor 91B.

In the medium transportation device 40C, the phases of rotation of the first uneven roller 45-1 and the second uneven roller 45-2 are controlled by the control unit 18. The control unit 18 controls the motors 91A and 91B such that the protrusion portions Sc1 that are formed at the second surface S2 of the medium P by the first uneven roller 45-1 and the protrusion portions Sc2 that are formed at the first surface S1 of the medium P by the second uneven roller 45-2 are made offset from each other in the medium transportation direction.

Note that a control unit other than the control unit 18 that is provided in the recording apparatus 2 may control the phases of rotation of the first uneven roller 45-1 and the second uneven roller 45-2.

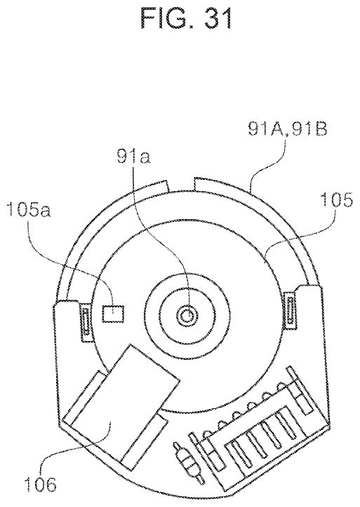

Hereinafter, control performed by the control unit 18 will be further described. As shown in FIG. 31, each of the motors 91A and 91B is provided with a rotation scale 105 and an encoder 106. The rotation scale 105 is provided at the motor shaft 91a, and the encoder 106 detects rotation of the rotation scale 105 and transmits a detection signal to the control unit 18. Accordingly, the control unit 18 can detect the amounts of rotation of the motors 91A and 91B. That is, the control unit 18 can detect the amount of rotation of each of the first uneven roller 45-1 and the second uneven roller 45-2.

A reference detection mark 105a is provided at a portion of the rotation scale 105 and the control unit 18 can detect the reference position of each of the first uneven roller 45-1 and the second uneven roller 45-2 with the encoder 106 detecting the reference detection mark 105a.

When the first uneven roller 45-1 and the second uneven roller 45-2 are at the reference positions, the protrusion portions 61B are in a state of abutting the medium P straight.

In a configuration in which the shaft-to-shaft distance Da is an integral multiple of the pitch interval pa, the control unit 18 can make the protrusion portions Sc1 formed at the second surface S2 of the medium P and the protrusion portions Sc2 formed at the first surface S1 offset from each other as shown in FIG. 27 by performing control such that the following equation (3) is satisfied, where Vs is a medium transportation speed and Δt is a time interval between reference position detection timing of the motor 91A and reference position detection timing of the motor 91B.

$$pa / 2 = Vs \times Δ t \qquad ( 3 )$$

As described above, the medium transportation devices 40B and 40C include the first transportation roller pair 41-1 and the second transportation roller pair 41-2, the first uneven roller 45-1 constituting the first transportation roller pair 41-1 comes into contact with the first surface S1 of the medium P, and the second uneven roller 45-2 constituting the second transportation roller pair 41-2 comes into contact with the second surface S2 of the medium P.

Accordingly, the degree of a difference between protrusions and recesses formed at the first surface S1 of the medium P and protrusions and recesses formed at the second surface S2 can be suppressed and generation of a curl of which an inner side is at the first surface S1 or the second surface S2 can be suppressed.

In addition, in the medium transportation devices 40B and 40C, the position of contact of the protrusion portion 61B of the first uneven roller 45-1 and the position of contact of the protrusion portion 61B of the second uneven roller 45-2 are different from each other.

Accordingly, a difference between the protrusions and recesses formed at the first surface S1 and the protrusions and recesses formed at the second surface S2 can be suppressed and generation of a curl of which the inner side is at the first surface S1 or the second surface S2 can be more effectively suppressed.

Note that in the above-described embodiment, the position of contact of the protrusion portion 61B of the second uneven roller 45-2 in the medium transportation direction is an intermediate position between the positions of contact of two protrusion portions 61B of the first uneven roller 45-1. However, the present disclosure is not limited thereto as long as the position of contact of the protrusion portion 61B of the first uneven roller 45-1 and the position of contact of the protrusion portion 61B of the second uneven roller 45-2 are different from each other.

In addition, the medium transportation device 40B includes the phase defining unit 102 that defines the phase of rotation of the first uneven roller 45-1 and the phase of rotation of the second uneven roller 45-2. Accordingly, ease of assembly of the device is improved.

In addition, the medium transportation device 40B includes the frame 100 that supports the first uneven roller 45-1 and the second uneven roller 45-2 and the phase defining unit 102 is composed of the phase alignment signs provided at the first uneven roller 45-1, the second uneven roller 45-2, and the frame 100. Thereby, the phase defining unit 102 can be configured with a simple structure.

In addition, in the medium transportation device 40B, the first uneven roller 45-1 and the second uneven roller 45-2 are driven by the motor 91 which is one drive source. Accordingly, the configuration of the device can be simplified and the cost of the device can be suppressed.

In addition, the medium transportation device 40C includes the motor 91A that is a first drive source rotating the first uneven roller 45-1, the motor 91B that is a second drive source rotating the second uneven roller 45-2, the encoder 106 that is a detection unit provided for each motor and detecting rotation of a roller driven by each motor, and the control unit 18 that controls each motor. In addition, the control unit 18 controls each motor such that a position where the protrusion portion 61B of the first uneven roller 45-1 comes into contact with the medium P and a position where the protrusion portion 61B of the second uneven roller 45-2 comes into contact with the medium P are made different from each other.

Accordingly, it is not necessary to adjust the phase of rotation of the first uneven roller 45-1 and the phase of rotation of the second uneven roller 45-2 in the assembly step and thus assembling the device is made easy. In addition, fine adjustment of the phase of rotation of the first uneven roller 45-1 and the phase of rotation of the second uneven roller 45-2 can be performed even after the device is assembled.

Note that the encoder 106 may detect rotation of a roller itself although the encoder 106 detects rotation of the motor shaft 91a in the above-described embodiment.

Note that in the medium transportation device 40C, the control unit 18 may adjust, based on a predetermined condition, the phase of rotation of the second uneven roller 45-2 with respect to the phase of rotation of the first uneven roller 45-1.

For example, when there is a change in printing density or environment, the speed of transportation may be changed and the phase of rotation of the second uneven roller 45-2 with respect to the phase of rotation of the first uneven roller 45-1 may be made offset. Therefore, when the control unit 18 adjusts the phase of rotation of the second uneven roller 45-2 with respect to the phase of rotation of the first uneven roller 45-1 based on the predetermined condition, the adjustment can be performed such that the phase of rotation of the second uneven roller 45-2 with respect to the phase of rotation of the first uneven roller 45-1 is made appropriate.

Note that in the medium transportation devices 40B and 40C as well, the protrusion portions 61B of the first protrusion portion row 61a (refer to FIG. 11) and the protrusion portions 61B of the second protrusion portion row 61b (refer to FIG. 11) are disposed at different positions in the circumferential direction. Therefore, it is possible to suppress formation of a noticeable line at the medium P along the axial direction, that is, the medium width direction.

Note that when the uneven ring 60A shown in FIGS. 4 to 10 is adopted for the medium transportation devices 40B and 40C, the protrusion portions 61A of the first protrusion portion row 61a (refer to FIG. 7) and the protrusion portions of the second protrusion portion row 61b (refer to FIG. 7) partially overlap with each other in the axial direction. Accordingly, it is possible to suppress formation of a noticeable line at the medium P along the medium transportation direction.

In addition, when the heater 112 (that is, a heating unit) described with reference to FIG. 37 is applied to the medium transportation devices 40B and 40C, the drying of the medium P can be performed in addition to curl correction of the medium P.

In addition, in the medium transportation devices 40B and 40C, the following action and effect can be achieved when the second surface S2 of the medium P (that is, a surface of the medium P that comes into contact with the second uneven roller 45-2) is a surface onto which ink is discharged last.

That is, regarding the first uneven roller 45-1 and the second uneven roller 45-2 of which outer peripheral surfaces are provided with protrusions and recesses, since the protrusion portions 61B come into contact with the medium P with a high pressure, transfer of ink is likely to occur when the protrusion portions 61B come into contact with an undried surface of the medium P.

However, since the second surface S2, which is a surface that comes into contact with the second uneven roller 45-2 positioned downstream of the first uneven roller 45-1 in the medium transportation direction, is a surface onto which ink is discharged last, the length of time until contact between the second surface S2 and the second uneven roller 45-2 can be lengthened. Accordingly, the second surface S2 can come into contact with the second uneven roller 45-2 in a state where the second surface S2 is dried and thus the transfer of ink is suppressed.

Note that such a configuration can be achieved by, for example, installing the medium transportation devices 40B and 40C in the second discharge path 16 (refer to FIG. 1) of the recording apparatus 2 in the recording system 1. This is because the second surface S2 faces an upper side when the second surface S2 on which recording is performed last in the recording apparatus 2 is transported through the second discharge path (refer to FIG. 1) as it is.

In addition, when the medium transportation devices 40B and 40C are installed at installation positions in the relay apparatus 3 or the post-processing apparatus 5 described with reference to FIG. 1, the second surface S2 on which recording is performed last in the recording apparatus 2 faces a lower side. Therefore, in such a case, the following action and effect can be achieved when the positions of the uneven roller 45B and the elastic roller 46 are vertically reversed for each of the first transportation roller pair 41-1 and the second transportation roller pair 41-2 in the medium transportation devices 40B and 40C.

In addition, in a configuration in which the heater 112 (that is, the heating unit) is provided as described above, in a case where the second surface S2 is a surface on which ink is discharged last, transfer of ink is further suppressed since drying is further promoted by the first uneven roller 45-1 when the medium P reaches the second uneven roller 45-2.

In addition, when a drying unit that dries the medium is further provided upstream of the first transportation roller pair 41-1 in the medium transportation direction, curl correction of the medium P is performed by the first transportation roller pair 41-1 and the second transportation roller pair 41-2 after drying of the medium P is promoted by the drying unit and thus transfer of ink attributable to the first transportation roller pair 41-1 or the second transportation roller pair 41-2 can be suppressed.

Examples of the drying unit include the relay apparatus 3 described with reference to FIG. 1. Therefore, in such a case, it is preferable that the medium transportation device 40B or the medium transportation device 40C is provided at a position in the relay apparatus 3 where the medium P is delivered to the post-processing apparatus 5, for example.

In the above-described medium transportation devices 40B and 40C, both the first facing roller and the second facing roller are the elastic rollers 46. However, the present disclosure is not limited thereto and the first facing roller and the second facing roller may be uneven rollers 45.

Configuration in which Both Rollers Constituting

### Transportation Roller Pair are Uneven Rollers

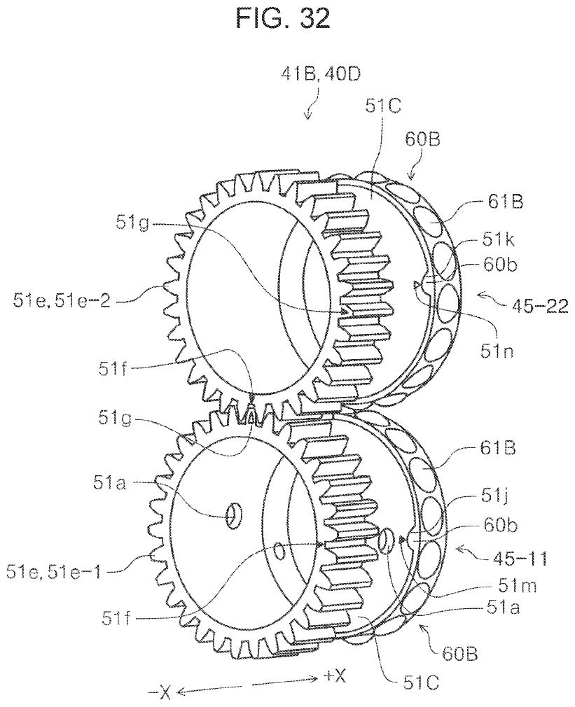

Next, a configuration in which both rollers constituting the transportation roller pair 41 are the uneven rollers 45 will be described with reference to FIGS. 32 to 36. Hereinafter, a medium transportation device in which both the rollers constituting the transportation roller pair 41 are the uneven rollers 45 will be referred to as a medium transportation device 40D although the entire body of the medium transportation device is not shown in the drawing.

As shown in FIG. 32, the medium transportation device 40D includes the transportation roller pair 41B. The transportation roller pair 41B includes a first uneven roller 45-11 and a second uneven roller 45-22. The first uneven roller 45-11 and the second uneven roller 45-22 are configured as the uneven rollers 45B.

Regarding the transportation roller pair 41B, the protrusion portion 61B of one of the first uneven roller 45-11 and the second uneven roller 45-22 faces the recess portion 62 of another of the first uneven roller 45-11 and the second uneven roller 45-22 in the same manner as described with reference to FIG. 3.

Note that in FIG. 32, for the sake of convenience of illustration, only reference portions 51C and the uneven rings 60B adjacent thereto are shown and other uneven rings 60B and the shaft portions 49 are not shown. Note that the reference portions 51C are fixed to the shaft portions 49 by the fixation pins 56 in the same manner as described with reference to FIG. 7.

The reference portions 51C are integrally provided with gears 51e. In the present embodiment, the first uneven roller 45-11 and the second uneven roller 45-22 have the same reference portions 51C as each other. However, hereinafter, the gear 51e of the first uneven roller 45-11 will be referred to as a first gear 51e-1 and the gear 51e of the second uneven roller 45-22 will be referred to as a second gear 51e-2 as necessary.

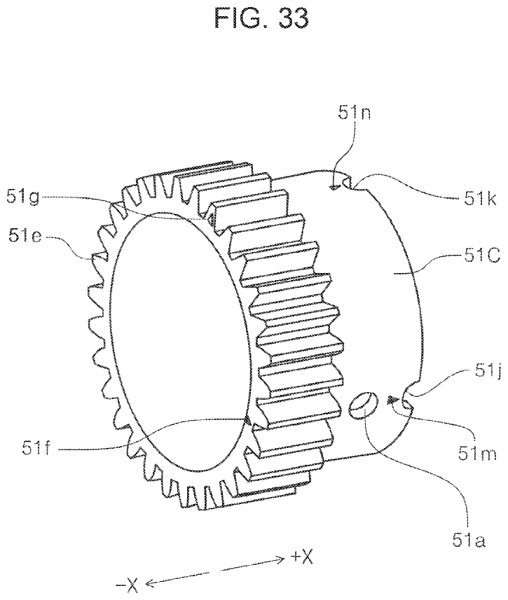

As shown in FIG. 33, at the reference portion 51C, a first engaged portion 51j and a second engaged portion 51k are formed to be open in the +X direction at an end portion in the +X direction. The first engaged portion 51j and the second engaged portion 51k are formed at different positions in the circumferential direction.

A first ring indication portion 51m is provided at the position of the first engaged portion 51j as a mark and a second ring indication portion 51n is provided at the position of the second engaged portion 51k as a mark. The first ring indication portion 51m and the second ring indication portion 51n are colored in different colors so that both the first ring indication portion 51m and the second ring indication portion 51n can be distinguished from each other. Note that the colors of the first ring indication portion 51m and the second ring indication portion 51n may be the same as each other as long as different shapes, letters, or the like are provided as the first ring indication portion 51m and the second ring indication portion 51n since both the first ring indication portion 51m and the second ring indication portion 51n only need to be distinguished from each other.

In addition, a first indication portion 51g and a second indication portion 51f are provided as marks at a gear surface of the gear 51e. The first indication portion 51g and the second indication portion 51f are formed at different positions in the circumferential direction. The first indication portion 51g and the second indication portion 51f are colored in different colors so that both the first indication portion 51g and the second indication portion 51f can be distinguished from each other. Note that the colors of the first indication portion 51g and the second indication portion 51f may be the same as each other as long as different shapes, letters, or the like are provided as the first indication portion 51g and the second indication portion 51f since both the first indication portion 51g and the second indication portion 51f only need to be distinguished from each other.

As shown in FIG. 32, regarding the uneven ring 60B adjacent to the reference portion 51C of the first uneven roller 45-11, the reference portion side engaging portion 60b as the first engaging portion is fitted to the first engaged portion 51j.

In addition, regarding the uneven ring 60B adjacent to the reference portion 51C of the second uneven roller 45-22, the reference portion side engaging portion 60b as the first engaging portion is fitted to the second engaged portion 51k.

In this manner, the first ring indication portion 51m and the second ring indication portion 51n colored in different colors can be used as signs at the time of assembly.

When assembly is performed in this manner, the position of the first indication portion 51g of the first uneven roller 45-11 corresponds to the position of a tooth of the first gear 51e-1 and corresponds to the position of the recess portion 62 of the first uneven roller 45-11. Furthermore, the position of the second indication portion 51f of the first uneven roller 45-11 corresponds to the position of a tooth groove of the first gear 51e-1 and corresponds to the position of the recess portion 62 of the first uneven roller 45-11.

In addition, the position of the first indication portion 51g of the second uneven roller 45-22 corresponds to the position of a tooth of the second gear 51e-2 and corresponds to the position of the protrusion portion 61B of the second uneven roller 45-22. Furthermore, the position of the second indication portion 51f of the second uneven roller 45-22 corresponds to the position of a tooth groove of the second gear 51e-2 and corresponds to the position of the protrusion portion 61B of the second uneven roller 45-22.

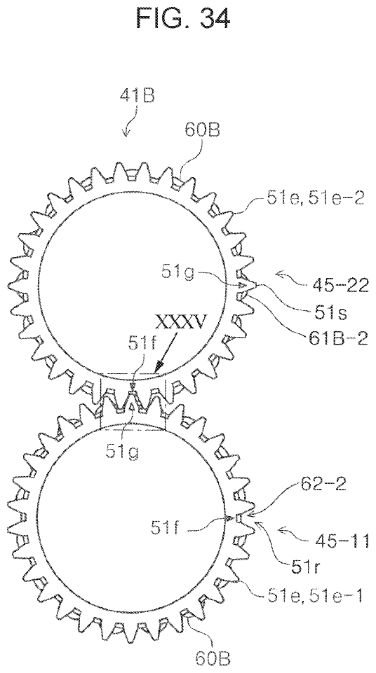

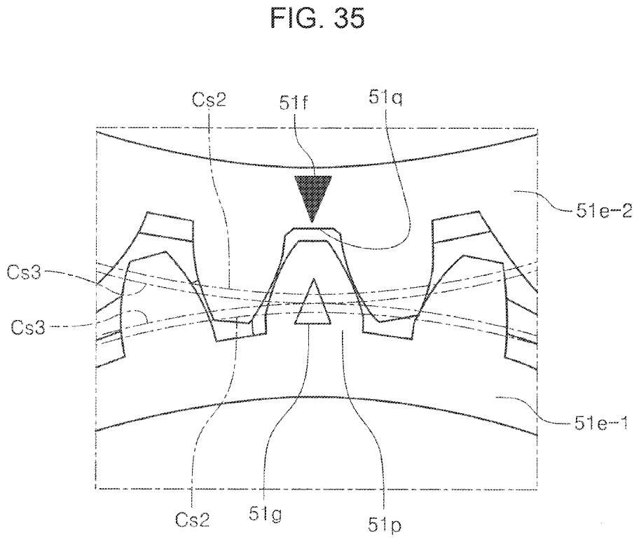

In addition, when the first gear 51e-1 and the second gear 51e-2 are to be caused to mesh with each other, the first gear 51e-1 and the second gear 51e-2 are caused to mesh with each other such that indication portions of which the colors are different from each other are brought together. In FIGS. 34 and 35, for example, the first indication portion 51g of the first gear 51e-1 and the second indication portion 51f of the second gear 51e-2 are brought together. However, the second indication portion 51f of the first gear 51e-1 and the first indication portion 51g of the second gear 51e-2 may also be brought together. In addition, the first gear 51e-1 and the second gear 51e-2 may be reversed.

When assembly is performed in this manner, a recess portion of one of the first uneven roller 45-11 and the second uneven roller 45-22 and a protrusion portion of another of the first uneven roller 45-11 and the second uneven roller 45-22 appropriately face each other when the first gear 51e-1 and the second gear 51e-2 are caused to mesh with each other.

As described above, the transportation roller pair 41B included in the medium transportation device 40D includes the first uneven roller 45-11 and the second uneven roller 45-22 and the protrusion portion 61B of one of the first uneven roller 45-11 and the second uneven roller 45-22 faces the recess portion 62 of another of the first uneven roller 45-11 and the second uneven roller 45-22. Accordingly, the degree of a difference between protrusions and recesses formed at the first surface S1 of the medium P and protrusions and recesses formed at the second surface S2 can be suppressed and generation of a curl of which an inner side is at the first surface S1 or the second surface S2 can be suppressed.

In addition, the medium transportation device 40D includes the first gear 51e-1 provided at the first uneven roller 45-11 and the second gear 51e-2 provided at the second uneven roller 45-22 and the first gear 51e-1 and the second gear 51e-2 mesh with each other. Accordingly, adjustment of the phase of rotation of the first uneven roller 45-11 and the phase of rotation of the second uneven roller 45-22 can be performed easily.

However, the present disclosure is not limited to such a configuration, and another gear may be interposed between the first gear 51e-1 and the second gear 51e-2.

In addition, in the medium transportation device 40D, a ratio between the number of the protrusion portions 61B of the first uneven roller 45-11 and the number of the protrusion portions 61B of the second uneven roller 45-22 is equal to a reduction ratio between the first gear 51e-1 and the second gear 51e-2. Accordingly, the phase of rotation of the first uneven roller 45-11 and the phase of rotation of the second uneven roller 45-22 being offset from each other as the rollers rotate can be suppressed.

For example, in the present embodiment, the ratio between the number of the protrusion portions 61B of the first uneven roller 45-11 and the number of the protrusion portions 61B of the second uneven roller 45-22 is 1 and the reduction ratio between the first gear 51e-1 and the second gear 51e-2 is also 1. However, the present disclosure is not limited thereto and for example, the number of teeth of the first gear 51e-1 may be two times the number of teeth of the second gear 51e-2 when the number of the protrusion portions 61B of the first uneven roller 45-11 is two times the number of the protrusion portions 61B of the second uneven roller 45-22.

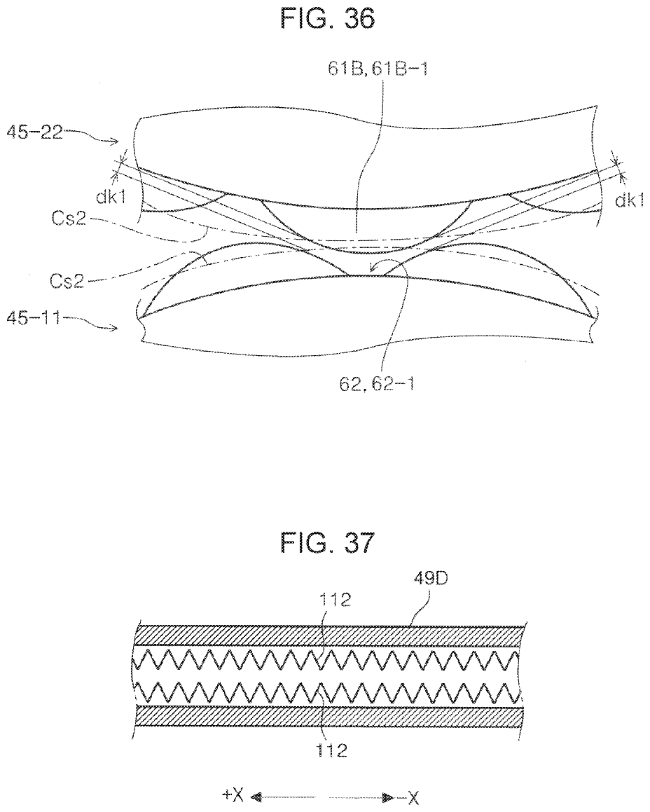

In addition, in the medium transportation device 40D, a gap dk1 is provided between the protrusion portion 61B of the first uneven roller 45-11 and the protrusion portion 61B of the second uneven roller 45-22 as shown in FIG. 36.

Accordingly, generation of a noise accompanied by contact between the protrusion portion 61B of the first uneven roller 45-11 and the protrusion portion 61B of the second uneven roller 45-22 or wear of the protrusion portions 61B can be suppressed.

Note that when the gap dk1 is provided between the protrusion portion 61B of the first uneven roller 45-11 and the protrusion portion 61B of the second uneven roller 45-22, a pitch circle Cs3 (refer to FIG. 35) of the first gear 51e-1 is larger than the contact circle Cs2 (refer to FIG. 35) of the first uneven roller 45-11 and the pitch circle Cs3 (refer to FIG. 35) of the second gear 51e-2 is larger than the contact circle Cs2 (refer to FIG. 35) of the second uneven roller 45-22.

In addition, when the gap dk1 is provided between the protrusion portion 61B of the first uneven roller 45-11 and the protrusion portion 61B of the second uneven roller 45-22, the sum of the radius of a tip circle of the first gear 51e-1 and the radius of a tip circle of the second gear 51e-2 is larger than the sum of a distance from a rotation center of one of the first uneven roller 45-11 and the second uneven roller 45-22 to a tip end of the protrusion portion 61B and a distance from a rotation center of another of the first uneven roller 45-11 and the second uneven roller 45-22 to a bottom of the recess portion 62.

In addition, in the medium transportation device 40D, the position of a first recess portion 62-1, which is a recess portion of the first uneven roller 45-11, and the position of a first tooth 51p, which is a tooth of the first gear 51e-1, coincide with each other in the circumferential direction and the position of a first protrusion portion 61B-1, which is a protrusion portion of the second uneven roller 45-22 and faces the first recess portion 62-1, and the position of a first tooth groove 51q, which is a tooth groove of the second gear 51e-2, coincide with each other in the circumferential direction. The first tooth 51p of the first gear 51e-1 and the first tooth groove 51q of the second gear 51e-2 mesh with each other.

According to such a configuration, when the first tooth 51p of the first gear 51e-1 enters the first tooth groove 51q of the second gear 51e-2, the first recess portion 62-1 which is a recess portion of the first uneven roller 45-11 faces the first protrusion portion 61B-1 which is a protrusion portion of the second uneven roller 45-22. Accordingly, positional alignment of the first recess portion 62-1 of the first uneven roller 45-11 and the first protrusion portion 61B-1 of the second uneven roller 45-22 is facilitated.

However, as described above, the second indication portion 51f of the first gear 51e-1 and the first indication portion 51g of the second gear 51e-2 may also be brought together. In such a case, the result is as follows when a tooth groove of the first gear 51e-1 at which the second indication portion 51f is provided is referred to as a second tooth groove 51r and a tooth of the second gear 51e-2 at which the first indication portion 51g is provided is referred to as a second tooth 51s as shown in FIG. 34. That is, the position of a first recess portion 62-2 of the first uneven roller 45-11 and the position of the second tooth groove 51r of the first gear 51e-1 coincide with each other in the circumferential direction and the position of a first protrusion portion 61B-2 of the second uneven roller 45-22 and the position of the second tooth 51s of the second gear 51e-2 coincide with each other in the circumferential direction. In addition, when the second indication portion 51f of the first gear 51e-1 and the first indication portion 51g of the second gear 51e-2 are brought together, the second tooth groove 51r of the first gear 51e-1 and the second tooth 51s of the second gear 51e-2 mesh with each other and the position of the first recess portion 62-2 of the first uneven roller 45-11 and the position of the first protrusion portion 61B-2 of the second uneven roller 45-22 are brought together. Even when such a configuration is adopted, positional alignment of the first recess portion 62-2 of the first uneven roller 45-11 and the first protrusion portion 61B-2 of the second uneven roller 45-22 is facilitated.

In addition, in the medium transportation device 40D, the first gear 51e-1 includes the first indication portion 51g indicating the position of the first tooth 51p and the second gear 51e-2 includes the second indication portion 51f indicating the position of the first tooth groove 51q. Accordingly, it is possible to easily cause the first tooth 51p to enter the first tooth groove 51q.

Note that, for example, the first indication portion 51g may not be provided at the position of a tooth and the first indication portion 51g may be provided at each of tooth grooves on both sides of a tooth to indicate the position of the tooth. Similarly, the second indication portion 51f may be provided at each of teeth on both sides of a tooth groove to indicate the position of the tooth groove.

In addition, in the medium transportation device 40D, as described with reference to FIGS. 4 to 13, the first uneven roller 45-11 and the second uneven roller 45-22 include the shaft portions 49, the reference portions 51 (51C) mounted on the shaft portions 49, the ring portions 52 that are positioned closer to the side, to which the +X direction extends, than the reference portions 51 are and that are mounted on the shaft portions 49, and the restriction portions 53 that are positioned closer to the side, to which the +X direction extends, than the ring portions 52 are and that are mounted on the shaft portions 49 to restrict movement of the ring portions 52 in the +X direction.

The ring portions 52 are composed of the plurality of uneven rings 60 disposed along the axial direction, the uneven ring 60 including the plurality of the protrusion portions 61 disposed along the circumferential direction. The first gear 51e-1 is provided at the reference portion 51 of the first uneven roller 45-11 and the second gear 51e-2 is provided at the reference portion 51 of the second uneven roller 45-22.

In addition, in the medium transportation device 40D, the uneven ring 60 includes the reference portion side engaging portion 60b that can engage with the reference portion 51 and the reference portion 51 includes the first engaged portion 51j that can engage with the reference portion side engaging portion 60b and the second engaged portion 51k that is provided at a position different from the position of the first engaged portion 51j in the circumferential direction.

When the reference portion side engaging portion 60b of the first uneven roller 45-11 engages with the first engaged portion 51j, the position of the first recess portion 62-1 and the position of the first tooth 51p coincide with each other in the circumferential direction. In addition, when the reference portion side engaging portion 60b of the second uneven roller 45-22 engages with the second engaged portion 51k, the position of the first protrusion portion 61B-1 and the position of the first tooth groove 51q coincide with each other in the circumferential direction. According to such a configuration, an assembly operation is facilitated.

Note that the reference portion side engaging portion 60b that engages with the first engaged portion 51j or the second engaged portion 51k of the reference portion 51 may be provided only for the uneven ring 60 adjacent to the reference portion 51 or may be provided for every uneven ring 60.

In addition, in the present embodiment, the first engaged portion 51j and the second engaged portion 51k of the reference portion 51 (that is, two engaged portions) are provided and the reference portion side engaging portion 60b (that is, one engaging portion) is provided at the uneven ring 60 adjacent to the reference portion 51. However, in contrast, the reference portion 51 may be provided with one engaged portion and the uneven ring 60 adjacent to the reference portion 51 may be provided with two engaging portions. In such a case, it is preferable that the one engaged portion of the reference portion 51 has a protruding shape and the two engaging portions of the uneven ring 60 have recessed shapes.

Note that in the medium transportation device 40D, the uneven ring 60 includes the restriction portion side engaging portion 60c (refer to FIGS. 11 and 12) that can engage with the restriction portion 53 and the reference portion side engaging portion 60b and the restriction portion side engaging portion 60c can engage with each other. Accordingly, it is not necessary to provide a configuration for the positioning of the uneven rings 60 and thus the configuration can be simplified.

In addition, in the medium transportation device 40D as well, the protrusion portions 61B of the first protrusion portion row 61a (refer to FIG. 11) and the protrusion portions 61B of the second protrusion portion row 61b (refer to FIG. 11) are disposed at different positions in the circumferential direction. Therefore, it is possible to suppress formation of a noticeable line at the medium P along the axial direction, that is, the medium width direction.

In addition, when the uneven ring 60A shown in FIGS. 4 to 10 is adopted for the medium transportation device 40D, the protrusion portions 61A of the first protrusion portion row 61a (refer to FIG. 7) and the protrusion portions of the second protrusion portion row 61b (refer to FIG. 7) partially overlap with each other in the axial direction. Accordingly, it is possible to suppress formation of a noticeable line at the medium P along the medium transportation direction.

In addition, when the heater 112 (that is, a heating unit) described with reference to FIG. 37 is applied to the medium transportation device 40D, the drying of the medium P can be performed in addition to curl correction of the medium P.

The present disclosure is not limited to the embodiments described above, and various modifications can be made within the scope of the appended claims, and as a matter of course, the modifications are also included in the scope of the present disclosure.

What is claimed is:

1. An uneven roller of which a surface coming into contact with a medium, onto which liquid is discharged, is provided with a plurality of protrusions and recesses, the uneven roller comprising:
a shaft portion;
a reference portion mounted on the shaft portion;
a ring portion that is positioned closer to a side, to which a first direction along an axial direction of the shaft portion extends, than the reference portion is and that is mounted on the shaft portion; and
a restriction portion that is positioned closer to the side, to which the first direction extends, than the ring portion is and that is mounted on the shaft portion to restrict movement of the ring portion in the first direction, wherein
the ring portion is composed of a plurality of uneven rings disposed along the axial direction, the uneven ring including a plurality of protrusion portions disposed along a circumferential direction.

2. The uneven roller according to claim 1, wherein
the plurality of uneven rings constituting the ring portion have the same shape as each other.

3. The uneven roller according to claim 1, wherein
the plurality of protrusion portions of the uneven ring are arranged in a row in the circumferential direction.

4. The uneven roller according to claim 1, wherein
two of the uneven rings that are adjacent to each other are configured to engage with each other.

5. The uneven roller according to claim 4, wherein
the uneven ring includes a reference portion side engaging portion configured to engage with the reference portion.

6. The uneven roller according to claim 5, wherein
the uneven ring includes a restriction portion side engaging portion configured to engage with the restriction portion.

7. The uneven roller according to claim 4, wherein
the uneven ring includes
a reference portion side engaging portion configured to engage with the reference portion, and
a restriction portion side engaging portion configured to engage with the restriction portion, and
the reference portion side engaging portion and the restriction portion side engaging portion are configured to engage with each other.

8. The uneven roller according to claim 7, wherein
the plurality of uneven rings include a first uneven ring and a second uneven ring positioned closer to the side, to which the first direction extends, than the first uneven ring is, and
a plurality of protrusion portions of the first uneven ring and a plurality of protrusion portions of the second uneven ring are disposed at different positions in the circumferential direction in a state where the restriction portion side engaging portion of the first uneven ring and the reference portion side engaging portion of the second uneven ring engage with each other.

9. The uneven roller according to claim 7, wherein
the uneven ring includes
a base portion into which the shaft portion is inserted, and
the protrusion portions protruding in a radial direction of the shaft portion from the base portion, and
the reference portion side engaging portion is provided at the base portion.

10. The uneven roller according to claim 7, wherein
the uneven ring includes
a base portion into which the shaft portion is inserted, and
the protrusion portions protruding in a radial direction of the shaft portion from the base portion, and
the restriction portion side engaging portion is provided at the base portion.

11. The uneven roller according to claim 7, wherein
the uneven ring includes
a base portion into which the shaft portion is inserted, and
the protrusion portions protruding in a radial direction of the shaft portion from the base portion, and
the plurality of protrusion portions are the reference portion side engaging portion.

12. The uneven roller according to claim 7, wherein
the uneven ring includes
a base portion into which the shaft portion is inserted, and
the protrusion portions protruding in a radial direction of the shaft portion from the base portion, and
the plurality of protrusion portions are the restriction portion side engaging portion.

13. The uneven roller according to claim 1, wherein
the restriction portion is pressed in a second direction which is a direction opposite to the first direction.

14. The uneven roller according to claim 1, wherein
the plurality of uneven rings include a first uneven ring and a second uneven ring positioned closer to the side, to which the first direction extends, than the first uneven ring is,
a plurality of protrusion portions of the first uneven ring and a plurality of protrusion portions of the second uneven ring are disposed at different positions in the circumferential direction, and
the plurality of protrusion portions of the first uneven ring and the plurality of protrusion portions of the second uneven ring partially overlap with each other in the axial direction.

15. A medium transportation device comprising:
the uneven roller according to claim 1 that is rotationally driven; and
a facing roller nipping, together with the uneven roller, a medium onto which liquid is discharged.

16. The medium transportation device according to claim 15, further comprising:
a heating unit heating the shaft portion.

17. A post-processing apparatus directly or indirectly coupled to a recording apparatus performing recording by discharging liquid onto a medium, the post-processing apparatus comprising:
a post-processing unit performing post-processing on the medium on which the recording is performed by the recording apparatus; and
the medium transportation device according to claim 15 that transports, toward the post-processing unit, the medium on which the recording is performed by the recording apparatus.

18. A relay apparatus that is disposed between a recording apparatus performing recording by discharging liquid onto a medium and a post-processing apparatus performing post-processing on the medium on which the recording is performed by the recording apparatus and that passes the medium from the recording apparatus to the post-processing apparatus, the relay apparatus comprising:
the medium transportation device according to claim 15.

19. An uneven ring constituting an uneven roller of which a surface coming into contact with a medium, onto which liquid is discharged, is provided with a plurality of protrusions and recesses, wherein
the uneven ring is configured to be mounted on a shaft portion constituting the uneven roller and includes a plurality of protrusion portions disposed along a circumferential direction.

20. A manufacturing method of an uneven roller of which a surface coming into contact with a medium, onto which liquid is discharged, is provided with a plurality of protrusions and recesses, the manufacturing method comprising:
mounting a reference portion on a shaft portion;
forming a ring portion by repeatedly sliding an uneven ring, which includes a plurality of protrusion portions disposed along a circumferential direction, onto the shaft portion toward the reference portion a plurality of times; and
mounting, onto the shaft portion, a restriction portion restricting movement of the ring portion in a direction away from the reference portion.
